(19) United States
(12) Patent Application Publication
(10) Pub. No.: US 2025/0242241 A1
(43) Pub. Date: Jul. 31, 2025

(54) VIRTUAL SCENE DISPLAY METHOD AND APPARATUS, DEVICE, STORAGE MEDIUM, AND PROGRAM PRODUCT

(71) Applicant: Tencent Technology (Shenzhen) Company Limited, Shenzhen (CN)

(72) Inventor: Yizhou Li, Shenzhen (CN)

(21) Appl. No.: 19/078,827

(22) Filed: Mar. 13, 2025

Related U.S. Application Data
(63) Continuation of application No. PCT/CN2024/072318, filed on Jan. 15, 2024.

(30) Foreign Application Priority Data
Mar. 7, 2023 (CN) 2023102457171

(51) Int. Cl. A63F 13/52

(52) U.S. Cl. CPC A63F 13/52

(57) ABSTRACT

A virtual scene display method and apparatus, a device, a storage medium, and a program product relate to the field of computer technologies and are described. The method may include displaying a virtual scene at a viewing angle of a first virtual object; receiving a control operation on the first virtual object; and displaying an illumination special effect in response to determining that a stance of the first virtual object matches a lighting direction of a virtual lighting prop equipped in a second virtual object in a case that the second virtual object is within a viewing angle range of the first virtual object and the virtual lighting prop is in an illumination state

### RELATED APPLICATION

This application is a continuation application of PCT Application PCT/CN2024/072318, filed Jan. 15, 2024, which claims priority to Chinese Patent Application No. 202310245717.1, filed on Mar. 7, 2023, each entitled “VIRTUAL SCENE DISPLAY METHOD AND APPARATUS, DEVICE, STORAGE MEDIUM, AND PROGRAM PRODUCT”, and each which is incorporated herein by reference in its entirety.

### TECHNICAL FIELD

Aspects described herein relate to the field of computer technologies, and in particular, to a virtual scene display method and apparatus, a device, a storage medium, and a program product.

### BACKGROUND

With the improvement of cultural and entertainment living standards, people have increasingly high requirements on a virtual scene (e.g., computer-generated virtual environment). As a representation manner of the virtual scene, a game may provide a channel for many people to release pressure and relieve stress. Various virtual props are provided for players in current game applications, and the game experience of players can be enriched by using the virtual props.

In the related art, a player uses a prop function of a virtual prop to implement different forms operations in a game process. When in a dark virtual environment, a player may use a virtual lighting prop (such as a virtual flashlight) to implement a lighting function, to light up the virtual environment, e.g., to improve an investigation effect in the dark virtual environment.

However, when the player uses the virtual lighting prop, if the player wants to use another prop to suppress an attack from another virtual object, the player needs to select another prop from a prop backpack and perform a prop switching operation. The operation process is relatively complex, and various game interfaces and props are rendered, causing a waste of computing resources.

### SUMMARY

Aspects described herein provide a virtual scene display method and apparatus, a device, a storage medium, and a program product. Line-of-sight blocking can be performed on a first virtual object conforming to a lighting direction matching relationship by using a virtual lighting prop, which may then be used to determine interference with an attack form of the first virtual object, thereby reducing an effective attack probability of the first virtual object. A player can resist an attack from another virtual player while using the virtual lighting prop to perform illumination, thereby reducing a waste of computing resources. Technical solutions are as follows:

According to one aspect, a virtual scene display method is provided, performed by a first device and including:

displaying a virtual scene at a viewing angle of a first virtual object, the virtual scene including a second virtual object, the second virtual object being equipped with a virtual lighting prop, and the virtual lighting prop being a virtual prop having a lighting function;

receiving a control operation on the first virtual object, the control operation being configured for controlling the first virtual object to perform an activity in the virtual scene; and

displaying an illumination special effect in response to that a stance of the first virtual object in the virtual scene matches a lighting direction of the virtual lighting prop in a case that the second virtual object is within a viewing angle range of the first virtual object and the virtual lighting prop equipped in the second virtual object is in an illumination state, the illumination special effect being configured for line-of-sight blocking at an observation viewing angle of the first virtual object for the virtual scene.

According to another aspect, a virtual scene display method is provided, performed by a second device and including:

displaying a virtual scene including a first virtual object, the virtual scene being displayed at a viewing angle of a second virtual object, the second virtual object being equipped with a virtual lighting prop, and the virtual lighting prop being a virtual prop having a lighting function;

receiving a prop control operation on the virtual lighting prop, the prop control operation being configured for adjusting a prop status of the virtual lighting prop to an illumination state; and

displaying an illumination light beam in a case that the first virtual object is within a viewing angle range of the second virtual object and a stance of the first virtual object in the virtual scene matches a lighting direction of the virtual lighting prop, the illumination light beam being configured for displaying an illumination special effect for line-of-sight blocking at an observation viewing angle of the first virtual object for the virtual scene.

According to another aspect, a virtual scene display apparatus is provided, where the apparatus includes:

a scene displaying module, configured to display a virtual scene at a viewing angle of a first virtual object, the virtual scene including a second virtual object, the second virtual object being equipped with a virtual lighting prop, and the virtual lighting prop being a virtual prop having a lighting function;

an operation receiving module, configured to receive a control operation on the first virtual object, the control operation being configured for controlling the first virtual object to perform an activity in the virtual scene; and

a special effect displaying module, configured to display an illumination special effect in response to that a stance of the first virtual object in the virtual scene matches a lighting direction of the virtual lighting prop in a case that the second virtual object is within a viewing angle range of the first virtual object and the virtual lighting prop equipped in the second virtual object is in an illumination state, the illumination special effect being configured for line-of-sight blocking at an observation viewing angle of the first virtual object for the virtual scene.

According to another aspect, a virtual scene display apparatus is provided, where the apparatus includes:

a scene displaying module, configured to display a virtual scene including a first virtual object, the virtual scene being displayed at a viewing angle of a second virtual object, the second virtual object being equipped with a virtual lighting prop, and the virtual lighting prop being a virtual prop having a lighting function;

an operation receiving module, configured to receive a prop control operation on the virtual lighting prop, the prop control operation being configured for adjusting a prop status of the virtual lighting prop to an illumination state; and

a special effect displaying module, configured to display an illumination light beam in a case that the first virtual object is within a viewing angle range of the second virtual object and a stance of the first virtual object in the virtual scene matches a lighting direction of the virtual lighting prop, the illumination light beam being configured for displaying an illumination special effect for line-of-sight blocking at an observation viewing angle of the first virtual object for the virtual scene.

According to another aspect, a computer device is provided, including a processor and a memory, the memory having at least one instruction, at least one segment of program, a code set, or an instruction set stored therein, and the at least one instruction, the at least one segment of program, the code set, or the instruction set being loaded and executed by the processor to implement the virtual scene display methods according to any one of the foregoing aspects.

According to another aspect, a non-transitory computer-readable storage medium is provided, having at least one instruction, at least one segment of program, a code set, or an instruction set stored therein, the at least one instruction, the at least one segment of program, the code set, or the instruction set being loaded and executed by a processor to implement the virtual scene display methods according to any one of the foregoing aspects.

According to another aspect, a computer program product or a computer program is provided, the computer program product or the computer program including computer instructions, and the computer instructions being stored in a computer-readable storage medium. A processor of a computer device reads the computer instructions from the computer-readable storage medium and executes the computer instructions, to enable the computer device to perform the foregoing virtual scene display methods according to any one of the foregoing aspects.

Aspects described herein provide at least the following beneficial effects:

displaying a virtual scene at a viewing angle of a first virtual object, controlling, based on a control operation of the first virtual object, the first virtual object to perform an activity in the virtual scene, and displaying an illumination special effect for line-of-sight blocking at an observation viewing angle of the first virtual object for the virtual scene if a stance of the first virtual object in the virtual scene matches a lighting direction of a virtual lighting prop equipped in a second virtual object in a case that the second virtual object is within a viewing angle range of the first virtual object and the virtual lighting prop is in an illumination state. In addition to the lighting utility of the virtual lighting prop, line-of-sight blocking utility is added for the virtual lighting prop, so that line-of-sight blocking is performed on a first virtual object conforming to a matching relationship by using the virtual lighting prop, which may interfere with an attack form of the first virtual object, thereby reducing an effective attack probability of the first virtual object. When a player uses the virtual lighting prop, the player may interfere with another virtual object without performing an additional operation, thereby reducing a waste of computing resources. In addition, according to the virtual lighting prop provided in this application, functions of lighting and interference with an attack are both considered, to avoid an inefficient problem that only an additional operation can interfere with another virtual object, thereby improving human computer interaction efficiency.

### BRIEF DESCRIPTION OF THE DRAWINGS

FIG. 1 is a structural block diagram of an example electronic device according to one or more aspects described herein.

FIG. 2 is a structural block diagram of an example computer system according to one or more aspects described herein.

FIG. 3 is a flowchart of an example virtual scene display method according to one or more aspects described herein.

FIG. 4 is an example schematic interface diagram of displaying a virtual light beam in a virtual scene according to one or more aspects described herein.

FIG. 5 is a flowchart of another example virtual scene display method according to one or more aspects described herein.

FIG. 6 is an example schematic interface diagram of displaying an illumination special effect according to one or more aspects described herein.

FIG. 7 is another example schematic interface diagram of displaying an illumination special effect according to one or more aspects described herein.

FIG. 8 is another example schematic interface diagram of displaying an illumination special effect according to one or more aspects described herein.

FIG. 9 is another example schematic diagram of an interference range according to one or more aspects described herein.

FIG. 10 is another example flowchart of a virtual scene display method according to one or more aspects described herein.

FIG. 11 is another example flowchart of a virtual scene display method according to one or more aspects described herein.

FIG. 12 is another example schematic diagram of a location relationship between an illuminator and an illuminated person according to one or more aspects described herein.

FIG. 13 is another example schematic diagram of a brightness curve of an included angle-halo special effect according to one or more aspects described herein.

FIG. 14 is another example schematic diagram of a brightness curve of a distance-halo special effect according to one or more aspects described herein.

FIG. 15 is another example schematic interface diagram of a halo effect according to one or more aspects described herein.

FIG. 16 is another example schematic interface diagram of a halo effect according to one or more aspects described herein.

FIG. 17 is another example schematic interface diagram in which an illumination special effect disappears according to one or more aspects described herein.

FIG. 18 is a flowchart of another example virtual scene display method corresponding to a second virtual object according to one or more aspects described herein.

FIG. 19 is a structural block diagram of an example virtual scene display apparatus according to one or more aspects described herein.

FIG. 20 is a structural block diagram of another example virtual scene display apparatus according to one or more aspects described herein.

FIG. 21 is a structural block diagram of another example virtual scene display apparatus according to one or more aspects described herein.

FIG. 22 is a structural block diagram of an example terminal according to one or more aspects described herein.

### DETAILED DESCRIPTION

First, terms used herein are briefly introduced.

Virtual scene: refers to a virtual scene that a computer application program displays (or generates or provides) when running on a terminal. The virtual scene may be a simulated scene of a real scene (e.g., a real-world environment), a semi-simulated and semi-fictional scene, or a purely fictional scene. The virtual scene may be any one of a two-dimensional virtual scene, a 2.5-dimensional virtual scene, or a three-dimensional virtual scene, but are not limited to these examples. Aspects are described herein by using an example in which a virtual scene is a three-dimensional virtual scene.

Virtual model: refers to a computer model configured for imitating a real scene in a virtual scene. For example, the virtual model may occupy a volume in the virtual scene. For example, the virtual model may include: a terrain model, a building model, an animal and plant model, a virtual prop model, a virtual vehicle model, and a virtual object model. For example, the terrain model may include: a ground, a mountain and river, a water stream, a stone, a step, or the like. The building model may include: a house, an enclosure, a container, and a fixed facility inside a building: a table, a chair, a cabinet, a bed, or the like. The animal and plant model may include: a tree, a flower, a flying bird, and the like. The virtual prop model may include: a virtual attack prop, a medicine box, an airdrop, and the like. The virtual vehicle model may include: an automobile, a ship, a copter, and the like. The virtual object model may include: a person, an animal, a cartoon character, and the like.

Virtual role/virtual object: refers to a movable object in a virtual scene. The movable object may be a virtual object, a virtual animal, a cartoon character, or the like, for example, a person, an animal, a plant, a bucket, a wall, a stone, and the like that are displayed in a three-dimensional virtual scene. In some arrangements, the virtual object may be a three-dimensional model created based on a skeletal animation technology. Each virtual object may have its own shape and volume in the three-dimensional virtual scene, and may occupy a portion of space in the three-dimensional virtual scene.

A virtual scene display method described herein may include at least one of a plurality of virtual scenes such as a virtual shooting scenario and a virtual battle scenario. The foregoing scenarios are merely examples, and the virtual scene display method may also be applied to other scenarios, and the examples described herein are not limiting.

According to one or more aspects, a prompt interface or a pop-up window can be displayed, or voice prompt information can be outputted before collecting user-related data and when collecting user-related data. The prompt interface, the pop-up window, or the voice prompt information may be configured for prompting the user that user-related data is currently being collected. In this way, related operations of obtaining the user-related data might only start to be executed after obtaining a confirmation operation of the user on the prompt interface or the pop-up window. Otherwise (that is, the confirmation operation of the user on the prompt interface or the pop-up window is not obtained), the related operations of obtaining the user-related data may be ended, that is, the user-related data might not be obtained. In other words, in this application, all collected user data is collected with the consent and authorization of users. The collection, use, and processing of relevant user data may be configured to comply with the relevant laws, regulations, and standards of relevant countries and regions.

In some examples, a first device may be implemented as a first terminal, and a second device may be implemented as a second terminal. A terminal may be a desktop computer, a laptop computer, a mobile phone, a tablet computer, an ebook reader, a Moving Picture Experts Group Audio Layer III (MP3) player, a Moving Picture Experts Group Audio Layer IV (MP4) player, or the like. A computer application program supporting a virtual scene, for example, an application program supporting a three-dimensional virtual environment, may be installed and executed on the terminal. The application program may be a virtual reality application program, a three-dimensional map application program, a third-person shooting game (TPS), a first-person shooting game (FPS), a multiplayer online battle arena game (MOBA), a multiplayer gun battle survival game, a party game, and the like. In some arrangements, the application program may be a standalone application program, such as a standalone three-dimensional game application, or may be an online application program.

FIG. 1 is a structural block diagram of an example electronic device according to one or more aspects described herein. The electronic device 100 may include: an operating system 120 and an application program 122. The electronic device 100 may refer to a first device, or may refer to a second device. The first device and the second device may be the same device, or may be different devices.

The operating system 120 may be basic software provided for the application program 122 to perform secure access to computer hardware.

The application program 122 may be an application program supporting a virtual environment. In some arrangements, the application program 122 may be implemented as the application program supporting a virtual environment and installed and run (e.g., executed) in the foregoing mentioned terminal.

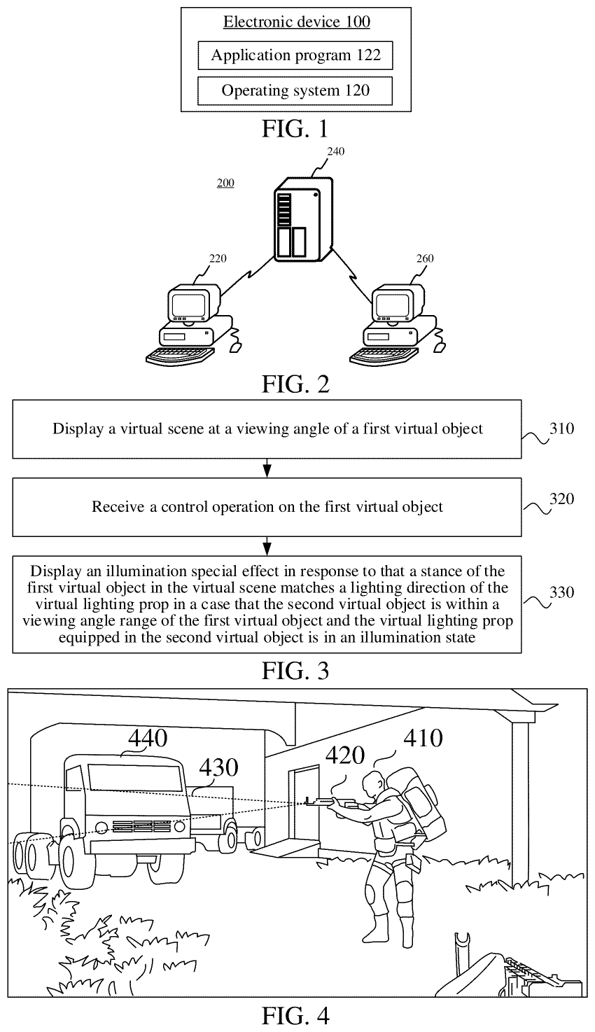

FIG. 2 is a structural block diagram of an example computer system according to one or more aspects described herein. The computer system 200 may include: a first device 220, a server 240, and a second device 260.

An application program supporting a virtual environment may be installed and executed in or by the first device 220. The application program may be implemented as the application program supporting a virtual environment and installed and run in the foregoing mentioned terminal. The first device 220 is a device used by a first user. The first user uses the first device 220 to control a first virtual object located in the virtual scene to perform an activity. The activity may include, but is not limited to, at least one of adjusting a body posture, crawling, walking, running, riding, jumping, driving, picking, shooting, attacking, and throwing. For example, the first virtual object may be a first virtual character, such as a simulated character role or a cartoon character role.

The first device 220 may be connected to the server 240 via a wireless network or a wired network.

The server 240 may include at least one of a server, a plurality of servers, a cloud computing platform, and a virtualization center. The server 240 may be configured to provide a backend service for an application program supporting a three-dimensional virtual environment. In some arrangements, the server 240 may be responsible for primary computing work, and the first device 220 and the second device 260 may be responsible for secondary computing work. Alternatively, the server 240 may be responsible for secondary computing work, and the first device 220 and the second device 260 may be responsible for primary computing work; alternatively, the server 240, the first device 220, and the second device 260 may perform collaborative computing by using a distributed computing architecture among each other.

An application program supporting a virtual environment may be installed and run in the second device 260. The application program may be implemented as the application program supporting a virtual environment and installed and run in the foregoing mentioned terminal. The second device 260 may be a device used by a second user. The second user may use the second device 260 to control a second virtual object located in the virtual scene to perform an activity. The activity may include, but is not limited to, at least one of adjusting a body posture, crawling, walking, running, riding, jumping, driving, picking, shooting, attacking, and throwing. For example, the second virtual object may be a second virtual character, such as a simulated character role or a cartoon character role. In some examples, the first virtual character and the second virtual character may be in the same virtual environment. In some arrangements, the first virtual character and the second virtual character may belong to the same team or the same organization, have a buddy relationship, or have a temporary communication permission. In some examples, the first virtual character and the second virtual character may alternatively belong to different teams, different organizations, or two groups hostile to each other.

In some arrangements, the application programs installed on the first device 220 and the second device 260 may be the same application program, or the application programs installed on the two devices may be the same type of application programs of different control system platforms. The first device 220 may generally refer to one of a plurality of devices, the second device 260 may generally refer to one of a plurality of devices. In this example, a description is provided by using only the first device 220 and the second device 260 as an example. The device types of the first device 220 and the second device 260 are the same or different.

The server 240 may be implemented as a physical server or a cloud server in the cloud. A cloud technology may refer to a hosting technology that unifies a series of resources such as hardware, software, and a network in a wide area network or a local area network to realize data calculation, storage, processing, and sharing. A cloud technology may be a general term of a network technology, an information technology, an integration technology, a management platform technology, and an application technology that are applied based on a cloud computing business model. The cloud technology may form a resource pool and be used as required, and is flexible and convenient. In some examples, the methods described herein may be applied to a cloud gaming scene, so that data logic calculation during a game is completed through the cloud server, and a terminal is responsible for displaying a game interface.

In some arrangements, the server 240 may alternatively be implemented as a node in a blockchain system.

The virtual scene display methods are described herein with reference to the foregoing brief introduction to nouns and application scenarios. An example in which a method is applied to the first device is used. As shown in FIG. 3, the method includes the following operation 310 to operation 330.

Operation 310: Display a virtual scene at a viewing angle of a first virtual object.

For example, the first virtual object may be a virtual object controlled by a player, and the player may use a first device (for example, a first terminal) to operate the first virtual object to perform an activity in a virtual scene corresponding to a computer game. The virtual scene displayed on the terminal may be a scene displayed at or from the viewing angle of the first virtual object. That is, the virtual scene may be a scene or perspective corresponding to the first virtual object. The viewing angle of the first virtual object may include a first-person viewing angle and a third-person viewing angle.

The first-person viewing angle may be configured for indicating a game viewing angle at which a player substitutes the first virtual object for observation. When the viewing angle of the first virtual object is a first-person viewing angle, the displayed virtual scene may be a scene that can be observed by the first virtual object (e.g., from the perspective of the first virtual object). In this case, the virtual scene might not include the first virtual object. Alternatively, the virtual scene may include a part of the first virtual object other than the head, for example, a palm or an arm. The third-person viewing angle may be configured for indicating that a player uses a game viewing angle independent of a virtual object in a game for observation. When the viewing angle of the first virtual object is a third-person viewing angle, the displayed virtual scene may usually be implemented as all scenes, some selected scenes, or the like in a game or the third-person viewing angle is implemented for all scenes, some scenes, or the like in a game. In this case, the virtual scene includes the first virtual object. In some examples, the virtual scene displayed from the third-person viewing angle may be further divided into a close scene, a middle scene, and a remote scene.

The virtual scene may be presented by using a camera in a game, and at a first-person viewing angle, the camera may be located near the head of a virtual object (for example, beside the head or on the head). At the third-person viewing angle, the camera may be located in the virtual scene, and can photograph or otherwise see/view the first virtual object. At the third-person viewing angle, the close scene may be configured for indicating that a photographing or viewing distance between the camera and a photographed object is short or close, and photographed or viewed content may be local content of the photographed object (for example, above the neck or above the waist). The middle scene may be configured for indicating that a photographing or viewing distance between the camera and a photographed object is relatively long or far, and photographed content may be most content of the photographed object (for example, above the knees) The remote scene may be configured for indicating that a photographing or viewing distance between the camera and a photographed object is long or far, and photographed content may be all content of the photographed object (that is, the photographed object entirely appears in a photographed picture of the remote scene).

In some arrangements, the viewing angle of the first virtual object may be determined based on a default operation of a game. Alternatively, the viewing angle of the first virtual object may be determined based on a self-defined selection operation of a player.

The virtual scene may include a second virtual object, and the second virtual object may be equipped with a virtual lighting prop.

For example, the second virtual object may be another virtual object different from the first virtual object in the game. For example, the second virtual object may be a virtual object controlled by another player. Alternatively, the second virtual object may be a virtual object allocated by a system by default, or the like.

In some arrangements, the second virtual object and the first virtual object may be virtual objects of the same camp, that is, the first virtual object and the second virtual object may have a teammate relationship in a game process. Alternatively, the second virtual object and the first virtual object may be virtual objects of different camps, that is, the first virtual object and the second virtual object may have a hostile relationship in a game process.

The virtual lighting prop may be a virtual prop having a lighting function, and may be configured for providing a lighting effect. In some arrangements, the virtual lighting prop may be a virtual prop collected or otherwise obtained by the second virtual object in the game process. Alternatively, the virtual lighting prop may be a virtual prop selected and equipped by the second virtual object before the game starts. Alternatively, the virtual lighting prop may be a virtual prop configured by the system for the second virtual object by default, or the like. For example, the virtual lighting prop may be implemented as at least one of virtual props having a light emitting function, such as a virtual flashlight, a virtual torch, a virtual light bulb, a virtual headlamp, virtual fireworks, and a virtual light stick.

Operation 320: Receive a control operation on the first virtual object.

The control operation may be configured for controlling the first virtual object to perform an activity in the virtual scene. In some examples, the activity may include at least one of movement and various actions. The movement may refer to that the first virtual object moves from a first location to a second location in the virtual scene. That is, a location of the first virtual object changes. The various actions may refer to a jumping action, a creeping action, a flipping action, or the like performed by the first virtual object in the virtual scene. For example, the player may control, by using different function controls (physical or soft inputs), the first virtual object to perform corresponding operations in the virtual scene. For example, the player may control, by using a move control, the first virtual object to perform a moving operation in the virtual scene. Alternatively, the player may control, by using a jump control, the first virtual object to perform a jumping operation in the virtual scene.

In some arrangements, the control operation may be implemented by controlling a virtual joystick. For example, the virtual joystick may be presented as a circle, and a process of adjusting a moving direction of the first virtual object may be implemented based on a slide operation on the virtual joystick.

In some arrangements, a control operation on the first virtual object may be received, and the first virtual object may move from the first location to the second location along a moving direction in the virtual scene. For example, based on a sliding operation of a player in a right direction on the virtual joystick, the first virtual object may move from the first location to the second location in the virtual scene in the right direction.

Operation 330: Display an illumination special effect in response to a stance of the first virtual object in the virtual scene matching a lighting direction of the virtual lighting prop in a case that the second virtual object is within a viewing angle range of the first virtual object and the virtual lighting prop equipped in the second virtual object is in an illumination state.

The viewing angle range of the first virtual object may be configured for indicating a range that can be observed by the first virtual object.

For example, the virtual scene may be a scene displayed at the viewing angle of the first virtual object. When the viewing angle of the first virtual object is implemented as a first-person viewing angle, the viewing angle range of the first virtual object may be implemented as a virtual scene displayed at the first-person viewing angle. When the viewing angle of the first virtual object is implemented as a third-person viewing angle, the viewing angle range of the first virtual object may be a range determined based on a location of the first virtual object in the virtual scene. That is, the virtual scene displayed at the third-person viewing angle may be different from that in the viewing angle range of the first virtual object.

In some arrangements, the viewing angle range of the first virtual object may be a viewing angle range preset by the system. In some arrangements, the viewing angle range of the first virtual object may include at least one of a distance range and an angle range.

For example, the viewing angle range of the first virtual object that is set by the system may be determined by both the distance range and the angle range, where the distance range is 0-100 m, and the angle range is 120°. That is, the viewing angle range of the first virtual object may be a sectoral region range formed by using the first virtual object as a vertex with an angle of 120° and a radius of 100 m.

The illumination state may be configured for indicating a state in which the virtual lighting prop is in an on state and performs a lighting function.

For example, under a condition that the second virtual object is equipped with the virtual lighting prop, when an enabling operation for the virtual lighting prop is received, the virtual lighting prop may be in the illumination state. For example, under a condition that the second virtual object is equipped with the virtual lighting prop, an on/off control corresponding to the virtual lighting prop may be displayed in a second device controlling the second virtual object, and the virtual lighting prop may be enabled to be in the illumination state in response to receiving a trigger operation for the on/off control.

In some arrangements, based on the second virtual object being located within the viewing angle range of the first virtual object, and the virtual lighting prop being equipped in the second virtual object is in the illumination state, the second virtual object and a prop operation animation of using the virtual lighting prop by the second virtual object may be displayed in the virtual scene displayed at the viewing angle of the first virtual object.

A virtual light beam presented by the virtual lighting prop based on the illumination state may be displayed in the prop operation animation. FIG. 4 is an example schematic interface diagram of displaying a virtual light beam in a virtual scene. The schematic interface diagram is a schematic diagram when the viewing angle of the first virtual object is implemented as a first-person viewing angle, and includes a second virtual object 410. The second virtual object 410 is equipped with a virtual lighting prop 420. In this case, the virtual lighting prop 420 is in an illumination state, and a virtual light beam 430 presented by the virtual lighting prop 420 based on the illumination state is displayed. Only a range of the virtual light beam 430 is illustrated in FIG. 4, and a real lighting effect is not shown. The virtual light beam 430 presented in FIG. 4 does not represent the real display effect of the virtual light beam 430. In some examples, the virtual light beam 430 may be implemented as a white light effect, a yellow light effect, a red light effect, or the like. The implementation of the virtual light beam 430 is not limited to these examples. The virtual light beam 430 may be presented in a “translucent” state, and might not shield another virtual element such as a virtual vehicle 440.

In some arrangements, when the second virtual object is within the viewing angle range of the first virtual object, and the virtual lighting prop of the second virtual object is in the illumination state, a lighting direction of the virtual lighting prop may be determined.

For example, the lighting direction may be a prop pointing direction of the virtual lighting prop, and may be configured for indicating a direction in which the virtual lighting prop illuminates. As shown in FIG. 4, the lighting direction of the virtual lighting prop 420 is the left front of the first virtual object, and may be the current orientation of the second virtual object 410.

In some arrangements, when the virtual lighting prop is implemented as a virtual flashlight, the lighting direction of the virtual lighting prop may usually be implemented as a prop orientation (the direction in which the virtual lighting prop emits illumination). When the virtual lighting prop is implemented as a virtual light bulb, the lighting direction of the virtual lighting prop may usually be implemented as a circular region with the virtual lighting prop as a center, or the like.

In some examples, after the lighting direction is determined, a matching relationship between the stance or position of the first virtual object in the virtual scene and the lighting direction may be determined.

The stance or position may include at least one of an object location and a location orientation. The object location may be configured for indicating a coordinate situation of the first virtual object in the virtual scene. The location orientation may refer to an orientation situation of a virtual object at its location, and may be usually implemented as a facial orientation situation of the virtual object. As shown in FIG. 4, a location orientation of the second virtual object 410 may be the left direction. A location orientation of the first virtual object may be configured for indicating an orientation situation of the first virtual object at its location.

After the lighting direction of the virtual lighting prop is determined, the facial orientation of the first virtual object at its location may be determined, and the facial orientation may be used as the location orientation of the first virtual object, to further determine the matching relationship between the location orientation and the lighting direction.

In some arrangements, the matching relationship may include at least a direction matching relationship between the location orientation and the lighting direction. For example, if an angle between the location orientation and the lighting direction conforms to a preset angle matching relationship, it may be considered that the location orientation and the lighting direction conform to the direction matching relationship.

In some arrangements, the matching relationship may further include a location matching relationship between the object location of the first virtual object and a prop location of the virtual lighting prop. For example, if a distance between the object location and the prop location conforms to a preset distance matching relationship, it may be considered that the object location and the prop location conform to the distance matching relationship.

In some arrangements, the matching relationship may be configured for indicating a location relative relationship between the location of the first virtual object and an interference range indicated by the lighting direction, and the matching relationship may include: the first virtual object matches the lighting direction, and the first virtual object does not match the lighting direction.

For example, the interference range indicated by the lighting direction may be determined according to the lighting direction, and after the object location of the first virtual object is determined, whether the object location is within the interference range may be determined. If the object location of the first virtual object is within the interference range, it may be considered or determined that the first virtual object matches the lighting direction. If the object location of the first virtual object is not within the interference range, it may be considered that the first virtual object does not match the lighting direction.

In some arrangements, the illumination special effect may be displayed when the stance or position of the first virtual object in the virtual scene matches the lighting direction of the virtual lighting prop. The illumination special effect may be configured for line-of-sight blocking at an observation viewing angle of the first virtual object for the virtual scene.

For example, line-of-sight blocking may be configured for indicating that the first virtual object cannot be enabled to comprehensively observe the virtual scene within a field of view range. For example, the illumination special effect can block the second virtual object, so that the first virtual object cannot observe the second virtual object, thereby helping the second virtual object perform self-protection by using the virtual lighting prop. Alternatively, the illumination special effect can block a specified article in a specified region, so that the first virtual object cannot effectively observe the specified article, thereby helping prevent the first virtual object from contending for the specified article with the second virtual object.

According to the virtual scene display methods described herein, a virtual scene may be displayed at a viewing angle of a first virtual object, based on a control operation of the first virtual object, the first virtual object may be controlled to perform an activity in the virtual scene, and an illumination special effect for line-of-sight blocking at an observation viewing angle of the first virtual object for the virtual scene may be displayed if a stance of the first virtual object in the virtual scene matches a lighting direction of a virtual lighting prop equipped in a second virtual object in a case that the second virtual object is within a viewing angle range of the first virtual object and the virtual lighting prop is in an illumination state. In addition to the lighting utility of the virtual lighting prop, line-of-sight blocking utility may be added for the virtual lighting prop, so that line-of-sight blocking may be performed on a first virtual object conforming to a matching relationship by using the virtual lighting prop, which may result in interfering with an attack form of the first virtual object, thereby reducing an effective attack probability of the first virtual object. When a player uses the virtual lighting prop, the player may interfere with another virtual object without performing an additional operation, thereby reducing a waste of computing resources. In addition, according to the virtual lighting prop provided in this application, functions of lighting and interference with an attack are both considered, to avoid an inefficiency problem in which an additional operation is required in order to interfere with another virtual object, thereby improving human computer interaction efficiency.

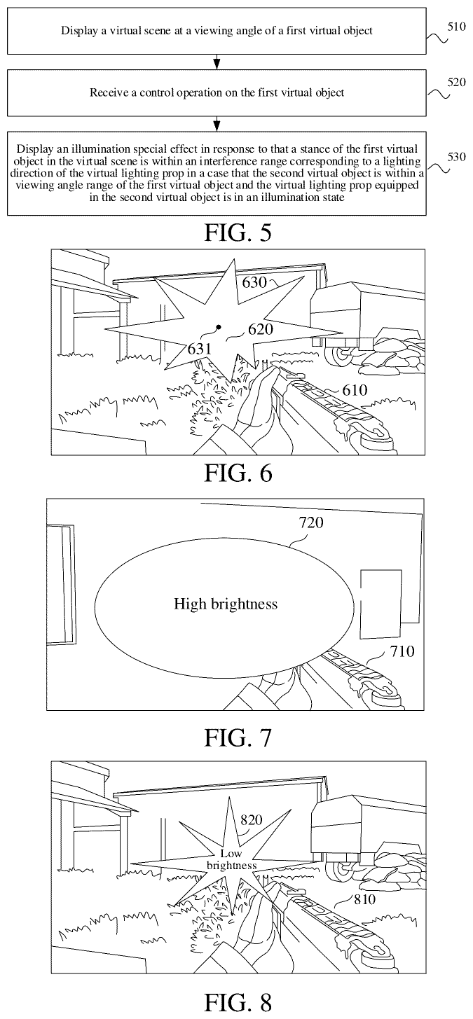

In one or more examples, whether the first virtual object is within an interference range capable of generating a visual interference effect may be determined according to a spacing distance between the first virtual object and the second virtual object and the matching relationship between the first virtual object and the lighting direction of the virtual lighting prop. For example, as shown in FIG. 5, aspects of FIG. 3 may further be implemented as the following operation 510 to operation 530.

Operation 510: Display a virtual scene at a viewing angle of a first virtual object.

The virtual scene may include a second virtual object, and the second virtual object may be equipped with a virtual lighting prop.

The virtual lighting prop may be a virtual prop having a lighting function. In some arrangements, the virtual lighting prop may be implemented as an independent virtual prop. For example, the virtual lighting prop may be implemented in a form of a virtual flashlight, a virtual torch, or the like. A player may independently equip and operate the virtual lighting prop. Alternatively, the virtual lighting prop may be implemented as an auxiliary virtual prop. For example, the virtual lighting prop may be implemented as a virtual flashlight accessory, configured to be assembled on another virtual prop to implement a lighting function.

Operation 520: Receive a control operation on the first virtual object.

The control operation may be configured for controlling the first virtual object to perform an activity in the virtual scene.

Operation 530: Display an illumination special effect in response to that a stance of the first virtual object in the virtual scene is within an interference range corresponding to a lighting direction of the virtual lighting prop in a case that the second virtual object is within a viewing angle range of the first virtual object and the virtual lighting prop equipped in the second virtual object is in an illumination state.

In some examples, when the second virtual object is located within the viewing angle range of the first virtual object and the virtual lighting prop of the second virtual object is in the illumination state, a location relative relationship between the location of the first virtual object and the interference range indicated by the lighting direction may be determined.

The location relative relationship may be configured for indicating whether the location of the first virtual object is located within the interference range corresponding to the lighting direction. The illumination special effect may be displayed when the location relative relationship indicates that the first virtual object is within the interference range corresponding to the lighting direction of the virtual lighting prop. The interference range may be configured for indicating a range in which a visual interference effect is generated for the first virtual object.

For example, FIG. 6 is an example schematic interface diagram of displaying an illumination special effect. The schematic interface diagram may be a schematic diagram when the viewing angle of the first virtual object is implemented as a first-person viewing angle. The first virtual object (not shown in the figure) may perform a virtual battle with a second virtual object 620 (blocked) by using a virtual attack prop 610. The second virtual object 620 may be located within the viewing angle range of the first virtual object, and the second virtual object 620 may be equipped with a virtual lighting prop (blocked). The virtual lighting prop may be in an illumination state. Because the first virtual object is located within an interference range corresponding to a lighting direction of the virtual lighting prop, an illumination special effect 630 may be displayed. That the illumination special effect 630 shown in FIG. 6 merely shows a range of the illumination special effect, and does not explicitly show a lighting effect of the illumination special effect. For example, the illumination special effect may be implemented as a high-intensity white light special effect, and an element in a virtual scene within a range corresponding to the illumination special effect 630 shown in FIG. 6 can be blocked.

The illumination special effect 630 may perform line-of-sight blocking at the observation viewing angle of the first virtual object for the virtual scene, and may block virtual elements including the second virtual object 620, so that the first virtual object cannot comprehensively observe the virtual scene within the field of view range, including that the first virtual object cannot observe the second virtual object 620 within the field of view range.

For example, the illumination special effect may be implemented as a high-brightness flashing effect. Under the high-brightness flashing effect, the first virtual object cannot effectively observe a region covered by the high-brightness flashing effect, thereby helping to reduce a probability of effectively attacking the covered region by the first virtual object.

As shown in FIG. 6, the region blocked by the illumination special effect 630 cannot be effectively observed, so that when the first virtual object launches an attack to the second virtual object 620 by using the virtual attack prop 610, because the second virtual object 620 is located in the region blocked by the illumination special effect 630, it may be relatively difficult for the first virtual object to effectively attack the second virtual object 620. As a result, the second virtual object 620 may improve its defense capability by using the virtual lighting prop.

Optionally, the illumination special effect centered on the virtual lighting prop may be displayed.

In some examples, the virtual lighting prop may be used as the center of the illumination special effect, to display an illumination special effect having a divergent effect. The divergent effect may be an effect of diverging outward and weakening gradually by using the virtual lighting prop as a point having highest brightness. For example, the virtual lighting prop may be used as the center of the illumination special effect, the center may be a point having highest brightness of the illumination special effect, and a brightness effect of the illumination special effect may be gradually weakened outward (e.g., in a radial direction). As shown in FIG. 6, a special effect center 631 of an illumination special effect 630 may be a point having highest brightness, and a brightness effect of the illumination special effect may be gradually weakened outward by using the point having highest brightness as the center. In this example, the illumination special effect may be implemented as a light effect that is centered on the lighting prop and that has a divergent effect, thereby improving display reality of the illumination special effect, and improving reality and immersion of the game.

According to one or more aspects, the illumination special effect may be displayed in response to an angle between an object orientation of the first virtual object and the lighting direction being less than a preset angle threshold. For example, when the location relative relationship between the location of the first virtual object and the interference range indicated by the lighting direction is determined, the angle between the object orientation of the first virtual object and the lighting direction may be determined.

The object orientation may be configured for indicating a direction that the first virtual object faces. When a facial orientation of the first virtual object may be used as the object orientation of the first virtual object, the angle between the object orientation and the lighting direction of the virtual lighting prop may be determined, and the angle may be compared with the preset angle threshold. The preset angle threshold may be an angle threshold that is set in advance and configured for limiting the interference range corresponding to the lighting direction. For example, the preset angle threshold may be within a range of 90° centering on the first virtual object.

The illumination special effect may be displayed when the angle between the object orientation and the lighting direction is less than the preset angle threshold; and no illumination special effect might be displayed when the angle between the object orientation and the lighting direction is greater than or equal to the preset angle threshold.

In this example, whether the illumination special effect is to be generated may need to be determined only by using a magnitude relationship between the angle between the object orientation of the first virtual object and the lighting direction and the preset angle threshold. A method for calculating an angle between directions may be relatively simple, and can reduce an amount of calculation required for processing, and determining based on a direction dimension can improve reasonableness of generating the illumination special effect.

In some arrangements, the virtual lighting prop may further have a lighting function, and may display a lighting special effect when the virtual lighting prop implements the lighting function. The lighting special effect may be configured for increasing display brightness of a virtual scene, and does not cause line-of-sight blocking. In some examples, the illumination special effect might not displayed and a lighting special effect may be displayed when the angle between the object orientation and the lighting direction is greater than or equal to the preset angle threshold.

Optionally, in response to a spacing distance between the first virtual object and the virtual lighting prop being less than a preset distance threshold, the illumination special effect may be displayed based on the spacing distance. For example, when the location relative relationship between the location of the first virtual object and the interference range indicated by the lighting direction is determined, the spacing distance between the first virtual object and the virtual lighting prop may be determined. Because the virtual lighting prop may be a virtual prop held by the second virtual object, the spacing distance between the first virtual object and the virtual lighting prop may be considered as a spacing distance between the first virtual object and the second virtual object.

After the spacing distance between the first virtual object and the virtual lighting prop is determined, the spacing distance may be compared with the preset distance threshold. The preset distance threshold may be a distance threshold that is set in advance and may be configured for limiting the interference range corresponding to the lighting direction.

In some arrangements, when it is determined that the spacing distance between the first virtual object and the virtual lighting prop is less than the preset distance threshold, the illumination special effect may be displayed based on the spacing distance. In some examples, the illumination special effect may be displayed based on an illumination special effect intensity corresponding to the spacing distance, and the illumination special effect intensity may have a negative correlation with the spacing distance.

For example, the illumination special effect intensity may be configured for indicating display brightness corresponding to the illumination special effect. After it is determined that the spacing distance is less than the preset distance threshold. Illumination special effects of different brightness degrees may be displayed according to the difference between the spacing distances. That is, when the spacing distance is smaller, display brightness of the illumination special effect may be higher, and when the spacing distance is larger, the display brightness of the illumination special effect may be lower.

FIG. 7 is an example schematic interface diagram of displaying an illumination special effect. The spacing distance between the first virtual object (a first-person viewing angle, not shown in the figure) holding a virtual attack prop 710 and the virtual lighting prop may be relatively small. In this case, display brightness of a displayed illumination special effect 720 may be relatively high (same as that described in FIG. 6, the illumination special effect 720 displayed in FIG. 7 merely shows a range of the illumination special effect, and does not show a lighting effect of the illumination special effect). In some arrangements, a virtual scene element blocked within a range corresponding to the illumination special effect 720 being substantially invisible may be considered as the transparency of a lighting effect filled in the illumination special effect 720 being about 95% to 100%. FIG. 8 is another example schematic interface diagram of displaying an illumination special effect. The spacing distance between the first virtual object (a first-person viewing angle, not shown in the figure) holding a virtual attack prop 810 and the virtual lighting prop may be relatively large. In this case, display brightness of a displayed illumination special effect 820 may be relatively low (same as that described in FIG. 6, the illumination special effect 820 displayed in FIG. 8 merely shows a range of the illumination special effect, and does not show a lighting effect of the illumination special effect). In some examples, visibility of a virtual scene element blocked within a range corresponding to the illumination special effect 820 may be low, but the virtual scene element might not be completely invisible. It may be considered that transparency of a lighting effect filled in the illumination special effect 820 is approximately 85% to 90%.

In the foregoing examples, on the one hand, whether an illumination special effect is to be generated may be determined only by using the magnitude relationship between the spacing distance between the first virtual object and the virtual lighting prop and the preset distance threshold. The method for calculating the distance may be relatively simple, and the amount of calculation required for processing can be reduced. On the other hand, a special effect intensity of an illumination special effect needing to be displayed can be determined by using the spacing distance, thereby improving diversity and flexibility of displaying of the illumination special effect.

In one or more examples, when the angle between the object orientation and the lighting direction is less than the preset angle threshold, and the spacing distance between the first virtual object and the virtual lighting prop is less than the preset distance threshold, the illumination special effect may be displayed based on the spacing distance between the first virtual object and the virtual lighting prop. For example, the interference range indicated by the lighting direction may be comprehensively determined by the preset distance threshold and the preset angle threshold. That is, the interference range may be related to two influencing factors, which are respectively a distance factor and an angle factor.

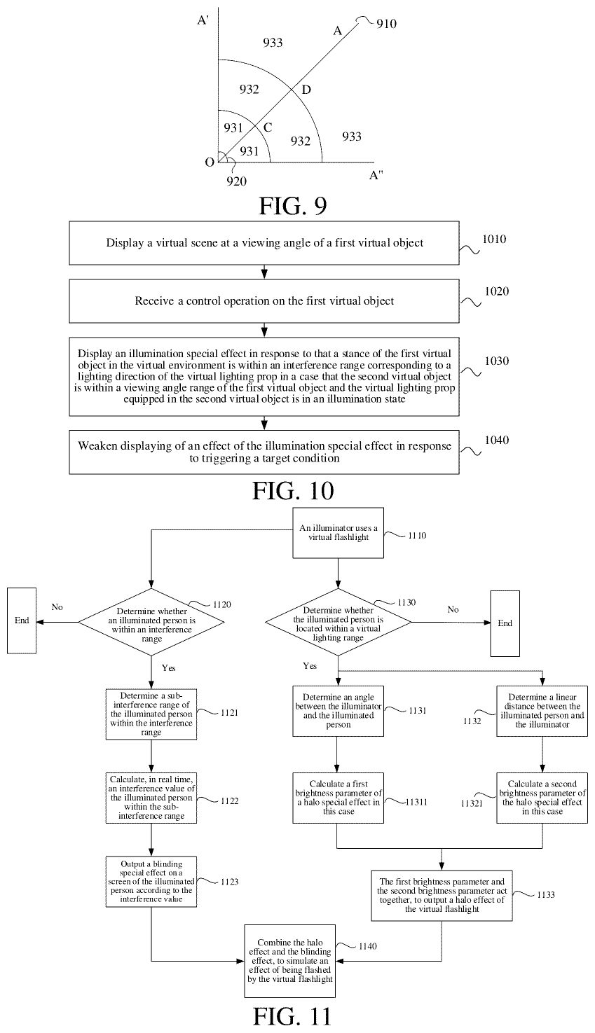

FIG. 9 is a schematic diagram of an example interference range. The interference range is comprehensively determined based on a line segment OA 910 (a preset distance threshold) and an angle A′OA″ 920 (a preset angle threshold).

In some arrangements, the interference range may have a plurality of sub-interference ranges, and the plurality of sub-interference ranges may correspond to different illumination special effect intensities.

The plurality of sub-interference ranges may be a plurality of region ranges obtained after the interference range is divided based on the preset distance threshold. For example, after the preset distance threshold is determined, the preset distance threshold may be divided to obtain a plurality of sub-line segments, and sub-interference ranges respectively corresponding to the plurality of sub-line segments may be obtained based on the plurality of sub-line segments and the preset angle threshold. That is, a plurality of sub-interference ranges may be obtained after the interference range is divided. For example, when the preset distance threshold is divided to obtain the plurality of sub-line segments, the plurality of sub-line segments may be obtained in an equal distance division manner, in an ascending distance division manner, in a random division manner, or the like.

As shown in FIG. 9, after an interference range bounded based on the line segment OA 910 and the angle A′OA″ 920 is obtained, the line segment OA 910 may be divided, to obtain a sub-line segment OC, a sub-line segment CD, and a sub-line segment DA. A sub-interference range 931 corresponding to the sub-line segment OC may be obtained based on the sub-line segment OC and the angle A′OA″ 920. A sub-interference range 932 corresponding to the sub-line segment CD may be obtained based on the sub-line segment CD and the angle A′OA″ 920. A sub-interference range 933 corresponding to the sub-line segment DA may be obtained based on the sub-line segment DA and the angle A′OA″ 920.

In some arrangements, an illumination special effect having a first illumination special effect intensity may be displayed in response to the first virtual object being located in a first sub-interference range of the interference range; and an illumination special effect having a second illumination special effect intensity may be displayed in response to the first virtual object being located in a second sub-interference range of the interference range, where a first distance between the first sub-interference range and the virtual lighting prop being less than a second distance between the second sub-interference range and the virtual lighting prop, and the first illumination special effect intensity being greater than the second illumination special effect intensity.

In the foregoing example, the interference range corresponding to the virtual lighting prop may be divided into a plurality of sub-interference ranges, an intensity of an illumination special effect needing to be displayed may be determined based on the sub-interference range in which the first virtual object is located, and the intensity of the illumination special effect may be determined based on the range rather than the location in the distance dimension, thereby reducing a quantity of illumination special effects of different intensities that need to be set, and reducing a waste of computing resources while exhibiting diversity.

In some arrangements, different sub-interference ranges may be preconfigured with different interference effective rates, and the interference effective rate may be configured for indicating an interference rate at which line-of-sight interference is generated to the first virtual object.

In some arrangements, an interference effective rate corresponding to the first sub-interference range may be obtained in response to the first virtual object being located in the first sub-interference range of the interference range. For example, as shown in FIG. 9, when the first virtual object is located in a first sub-interference range 931 of the interference range, an interference effective rate corresponding to the first sub-interference range 931 may be obtained.

In some arrangements, an interference value corresponding to the first virtual object may be obtained based on staying duration of the first virtual object in the first sub-interference range and the interference effective rate. For example, statistics about the staying duration of the first virtual object in the first sub-interference range may be collected, and the staying duration may be multiplied by the interference effective rate corresponding to the first sub-interference range, to obtain the interference value corresponding to the first sub-interference range. The interference value may be configured for indicating a degree of line-of-sight interference generated to the first virtual object.

In some examples, the illumination special effect having the first illumination special effect intensity may be displayed based on the interference value.

For example, according to a calculation result of the interference value, an illumination special effect having a special effect intensity corresponding to the interference value may be displayed.

For example, when the interference value is 100, line-of-sight interference may be generated to the first virtual object to a relatively strong extent. In this case, the line-of-sight of the first virtual object may be completely blocked. That is, the first virtual object may be completely unable to see the virtual scene clearly (e.g., a blinding effect is achieved). When the interference value is 30, line-of-sight interference may be generated to the first virtual object to a relatively weak extent. In this case, the line-of-sight of the first virtual object may be partially blocked. That is, the first virtual object might not clearly see some content in the virtual scene, and the like.

The following example uses the second sub-interference range as an example. An interference effective rate corresponding to the second sub-interference range may be obtained in response to the first virtual object being located in the second sub-interference range of the interference range; an interference value corresponding to the first virtual object may be obtained based on a staying duration of the first virtual object in the second sub-interference range and the interference effective rate; and the illumination special effect having the first illumination special effect intensity may be displayed based on the interference value corresponding to the first virtual object.

In the foregoing example, when the illumination special effect intensity of the illumination special effect is determined, the concept of the interference value may be introduced. The interference value may be determined based on the interference effective rate and the staying duration of the first virtual object in the first sub-interference range. That is, as the staying duration of the first virtual object in the first sub-interference range increases, the intensity of the illumination special effect may continuously increase, thereby improving a dynamic effect and variability in a process of displaying the illumination special effect, and improving game experience of a player.

In some arrangements, different sub-interference ranges may be preconfigured with different interference thresholds, and the interference thresholds may be configured for indicating upper limits of interference values in the corresponding sub-interference ranges. For example, as shown in FIG. 9, when the first virtual object is located within the first sub-interference range 931, it may be determined, based on a first interference threshold of the first sub-interference range 931, that the calculated interference value corresponding to the first virtual object needs to be within the first interference threshold. In some examples, if an illumination special effect of the first sub-interference range 931 is the strongest, the first interference threshold may be the maximum value in a plurality of sub-interference ranges.

Similarly, when the first virtual object is located within the second sub-interference range 932, it may be determined, based on a second interference threshold of the second sub-interference range 932, that the calculated interference value corresponding to the first virtual object needs to be within the second interference threshold. The second interference threshold may be less than the first interference threshold.

Additionally or alternatively, different sub-interference ranges may be preconfigured with different interference value intervals, and the interference value interval may be configured for indicating an interference value range limitation in a corresponding sub-interference range. For example, as shown in FIG. 9, when the first virtual object is located within the first sub-interference range 931, it may be determined, based on a first interference value interval of the first sub-interference range 931, that the calculated interference value corresponding to the first virtual object needs to be within the first interference value interval.

Similarly, when the first virtual object is located within the second sub-interference range 932, it may be determined, based on a second interference value interval of the second sub-interference range 932, that the calculated interference value corresponding to the first virtual object needs to be within the second interference value interval. In some arrangements, the minimum value of the first interference value interval may be greater than or equal to the maximum value of the second interference value interval. For example, the first interference value interval may be (90, 100), and the second interference value interval may be (40, 90). Alternatively, the first interference value interval may be (90, 100), and the second interference value interval may be (40, 60).

In some examples, the virtual lighting prop may correspond to a virtual lighting range, and the virtual lighting range may be configured for indicating a lighting range of the lighting function of the virtual lighting prop. In some examples, a virtual halo special effect may be displayed in response to the first virtual object being located outside the interference range and being located within the virtual lighting range, where the virtual halo special effect is a special effect formed by using the virtual lighting prop as a center.

For example, after the second virtual object enables the virtual lighting prop, the virtual lighting prop may have two key ranges: an interference range and a lighting range. The interference range may be implemented as a sector range shown in FIG. 9, and a point O may be implemented as a light emitting point of the virtual lighting prop (that is, the location of the virtual lighting prop). As shown in FIG. 9, assuming that there is a point E (not shown in FIG. 9) on an extension line of OA in FIG. 9, based on a line segment OE and the angle A′OA″ 920, it may be obtained that a sectoral range corresponding to the line segment OE is the virtual lighting range. Alternatively, a circular range using the point O as the center of the circle and the OE as the radius may be the virtual lighting range. These examples are not limiting. In the foregoing examples, when the first virtual object is located outside the interference range and is located within the virtual lighting range, a virtual halo effect may be further displayed for reflecting the lighting function of the virtual lighting prop, thereby improving realism of the virtual lighting prop, and improving game experience of a player.

According to aspects described herein, an interference range in which a visual interference effect is generated to a first virtual object may be determined based on a lighting direction, and illumination special effects of different special effect degrees may be differently displayed according to a location status of the first virtual object within the interference range. When the first virtual object and a second virtual object are relatively close and have a relatively small angle, an illumination special effect with a stronger special effect degree may be displayed, and when the first virtual object and the second virtual object are relatively far and have a relatively large angle, an illumination special effect with a weaker special effect degree may be displayed, thereby fully improving simulation of a game, enhancing fun of the game, and improving a sense of game participation of a player.

In one or more arrangements, the illumination special effect may be configured for reducing an effective attack probability of the first virtual object, so that the second virtual object can perform a game attack resistance process by using the virtual lighting prop. For example, as shown in FIG. 10, aspects of FIG. 3 may further be implemented as the following operation 1010 to operation 1040.

Operation 1010: Display a virtual scene at a viewing angle of a first virtual object.

The virtual scene may include a second virtual object, and the second virtual object may be equipped with a virtual lighting prop.

Operation 1010 is described in the foregoing operation 310 and operation 510, and details are not described herein again.

Operation 1020: Receive a control operation on the first virtual object.

The control operation may be configured for controlling the first virtual object to perform an activity in the virtual scene.

Operation 1020 is described in the foregoing operation 320 and operation 520, and details are not described herein again.

Operation 1030: Display an illumination special effect in response to a stance of the first virtual object in the virtual environment being within an interference range corresponding to a lighting direction of the virtual lighting prop in a case that the second virtual object is within a viewing angle range of the first virtual object and the virtual lighting prop equipped in the second virtual object is in an illumination state.

In some arrangements, when the second virtual object is located within the viewing angle range of the first virtual object and the virtual lighting prop of the second virtual object is in the illumination state, a location relative relationship between the stance of the first virtual object in the virtual environment and the interference range indicated by the lighting direction may be determined. The location relative relationship may be configured for indicating whether the location of the first virtual object is located within the interference range corresponding to the lighting direction. The illumination special effect may be displayed when the location relative relationship indicates that the first virtual object is within the interference range corresponding to the lighting direction of the virtual lighting prop.

The interference range may be configured for indicating a range in which a visual interference effect is generated for the first virtual object.

According to some aspects, in response to the lighting direction of the virtual lighting prop pointing to a virtual reflective prop, a refracting direction corresponding to the lighting direction may be determined; and an interference range may be determined based on the refracting direction. For example, the virtual reflective prop may be a prop configured for refracting light emitted by the virtual lighting prop. For example, the virtual reflective prop may be implemented as an article/prop having a reflection function, such as a virtual mirror, a virtual water stream, or a virtual screen. When the lighting direction of the virtual lighting prop points to the virtual reflective prop, a refracting direction that presents normal symmetry with the lighting direction may be determined, and the interference range may be determined based on the refracting direction.

In some arrangements, the interference range may be determined by combining the refracting direction and the lighting direction. For example, a first interference range may be determined according to the lighting direction, a second interference range may be determined according to the refracting direction, and a union set of the first interference range and the second interference range may be used as the interference range. Alternatively, an intersection set of the first interference range and the second interference range may be used as the interference range.

In some arrangement, for descriptions of determining the interference range according to the refracting direction, refer to the descriptions provided herein for determining the interference range according to the lighting direction. For example, a preset distance threshold and a preset included angle threshold corresponding to the refracting direction may be predetermined, to determine the interference range corresponding to the refracting direction. Accordingly, details are not described herein again.

Optionally, the illumination special effect may be implemented as a brightness-gradient flashing effect. Alternatively, the illumination special effect may be implemented as a virtual smoke effect. Alternatively, the illumination special effect may be implemented as a flickering effect. Alternatively, the illumination special effect may be implemented as a virtual obstacle effect or the like. The flashing effect may be configured for indicating a lighting effect with intense brightness, and the intense brightness may be configured for indicating brightness sufficient for blocking the second virtual object and causing line-of-sight interference to the first virtual object. The flickering effect may be configured for indicating a lighting effect that flickers at a particular frequency, and the like.

In some arrangements, the illumination special effect may display different styles based on settings of a player. For example, the player may select the illumination special effect to be achieved as a brightness-gradient flashing effect, and may further select content such as a color and a shape of the illumination special effect. Alternatively, the player may select the illumination special effect to be implemented as virtual smoke and a flashing effect. When the level of the second virtual object is higher than that of the first virtual object, virtual smoke may be displayed, and when the level of the second virtual object is lower than that of the first virtual object, a flashing effect may be displayed.

Alternatively or additionally, in response to a display duration of the illumination special effect reaching preset display duration, displaying of the illumination special effect may be canceled. For example, the preset display duration may be configured for indicating display duration that is set in advance, for example, the preset display duration may be 5 seconds, and after the display duration of the illumination special effect reaches the preset display duration of 5 seconds, displaying of the illumination special effect may be canceled. That is, displaying of the illumination special effect causing line-of-sight blocking on the first virtual object may be canceled.

In some examples, the illumination special effect may be displayed based on a first object level of the first virtual object. For example, in response to the first object level of the first virtual object being within a first level range, an illumination special effect having the second illumination special effect intensity may be displayed. In response to the first object level of the first virtual object being within a second level range, an illumination special effect having the first illumination special effect intensity may be displayed.

In some arrangements, the first level range and the second level range may be preset level ranges. For example, the first object level of the first virtual object may be determined when the second virtual object uses the virtual lighting prop for lighting. The object level may be configured for measuring a game level of a virtual object in a form of a value. The object level may include a plurality of forms, such as a game level and an object interaction level. The game level may be implemented as a level determined based on a historical game battle, a level determined based on a current game, or the like. The object interaction level may be implemented as a level determined based on an interaction situation between virtual objects (for example, if an interaction frequency between the first virtual object and the second virtual object is relatively high, an object interaction level between the first virtual object and the second virtual object may be relatively high).

For example, after the first object level of the first virtual object is determined, a level range of the first object level may be determined. If the preset first level range is (50, 100), the preset second level range is (0, 49), and the first object level of the first virtual object is 46, it may be determined that the first object level of the first virtual object is within the second level range, and an illumination special effect having the first illumination special effect intensity corresponding to the second level range may be displayed. For example, the illumination special effect having the first illumination special effect intensity may be an illumination special effect having a relatively strong special effect intensity. An illumination special effect having the second illumination special effect intensity may be an illumination special effect having a relatively weak special effect intensity, and the like.

That is, when the second virtual object uses the virtual lighting prop to help cause line-of-sight interference to the first virtual object, based on the first object level of the first virtual object, a corresponding degree of resistance may be made to a line-of-sight blocking function of the illumination special effect generated by the virtual lighting prop. For example: when the first object level of the first virtual object is higher, the special effect intensity of the illumination special effect caused by the second virtual object by using the virtual lighting prop may be smaller, thereby motivating the player controlling the first virtual object to increase the first object level as quickly as possible to defend against the line-of-sight blocking function of the illumination special effect.

In some arrangements, the illumination special effect may be displayed based on the second object level of the second virtual object. For example, in response to the second object level of the second virtual object being within the first level range, an illumination special effect having the first illumination special effect intensity may be displayed. In response to the second object level of the second virtual object being within the second level range, an illumination special effect having the second illumination special effect intensity may be displayed.

In some arrangements, the first level range and the second level range may be preset level ranges. For example, the second object level of the second virtual object may be determined when the second virtual object uses the virtual lighting prop for lighting.

For example, after the second object level of the second virtual object is determined, a level range of the second object level may be determined. If the preset first level range is (50, 100), the preset second level range is (0, 49), and the second object level of the second virtual object is 46, it may be determined that the second object level of the second virtual object is within the second level range, and an illumination special effect having the second illumination special effect intensity corresponding to the second level range may be displayed. For example, an illumination special effect having the second illumination special effect intensity may be an illumination special effect having a relatively weak special effect intensity. The illumination special effect having the first illumination special effect intensity may be an illumination special effect having a relatively strong special effect intensity, and the like.

That is, when the second virtual object uses the virtual lighting prop to help cause line-of-sight interference to the first virtual object, based on the second object level of the second virtual object, the line-of-sight blocking function of the illumination special effect generated by the virtual lighting prop can be more fully exerted.

In some arrangements, the illumination special effect may be displayed based on a level difference between the first object level of the first virtual object and the second object level of the second virtual object. In some examples, the illumination special effect may be displayed in response to the first object level of the first virtual object being not greater (e.g., equal to or less than) than the second object level of the second virtual object; and the illumination special effect might not be displayed in response to the first object level of the first virtual object being greater than the second object level of the second virtual object.

For example, when the second virtual object uses the virtual lighting prop for lighting, the first object level of the first virtual object and the second object level of the second virtual object may be determined, and the first object level may be compared with the second object level. For example, if the first object level of the first virtual object is 46, and the second object level of the second virtual object is 88, the first object level of the first virtual object is less than the second object level of the second virtual object, and the illumination special effect may be displayed. Similarly, if the first object level of the first virtual object is 67, and the second object level of the second virtual object is 57, the first object level of the first virtual object is greater than the second object level of the second virtual object, and no illumination special effect may be displayed.

In some arrangements, an illumination special effect having the first illumination special effect intensity may be displayed in response to the first object level of the first virtual object being not greater than (e.g., equal to or less than) the second object level of the second virtual object; and an illumination special effect having the second illumination special effect intensity may be displayed in response to the first object level of the first virtual object being greater than the second object level of the second virtual object. For example, when the second virtual object uses the virtual lighting prop for lighting, the first object level of the first virtual object and the second object level of the second virtual object may be determined, and the first object level may be compared with the second object level. For example, if the first object level of the first virtual object is 46, and the second object level of the second virtual object is 88, the first object level of the first virtual object is less than the second object level of the second virtual object, and the illumination special effect having the first illumination special effect intensity may be displayed. Similarly, if the first object level of the first virtual object is 67, and the second object level of the second virtual object is 57, the first object level of the first virtual object is greater than the second object level of the second virtual object, and the illumination special effect having the second illumination special effect intensity may be displayed.

That is, when the second virtual object uses the virtual lighting prop to help cause line-of-sight interference to the first virtual object, the illumination special effect generated by the virtual lighting prop may be differently displayed by combining the first object level of the first virtual object and the second object level of the second virtual object, thereby helping and/or motivating a first player controlling the first virtual object to increase the first object level as soon as possible, to fully defend against the line-of-sight blocking function of the illumination special effect. This is also beneficial to helping and/or motivating a second player controlling the second virtual object to increase the second object level as soon as possible, to fully exert the line-of-sight blocking function of the illumination special effect.

Operation 1040: Weaken displaying of an effect of the illumination special effect in response to triggering a target condition.

For example, the target condition may be a preset condition. After the target condition is triggered, the effect of the illumination special effect may be weakened. In some arrangements, the target condition may include at least one of the following forms.
(1) In response to the second virtual object being located outside the viewing angle range of the first virtual object, the target condition is triggered.

For example, when the second virtual object is not within the viewing angle range of the first virtual object, an operation of using the virtual lighting prop by the second virtual object cannot be (or might not be) known by the first virtual object. Therefore, it may be considered that the target condition is triggered, to weaken displaying of the effect of the illumination special effect. In some examples, the second virtual object may be located outside the viewing angle range of the first virtual object, that is, the first virtual object moves or the second virtual object moves, so that the first virtual object gradually gets away from the interference range corresponding to the virtual lighting prop, the effect of the illumination special effect is weakened, and the blocked virtual scene element may gradually appear. Accordingly, the player can gradually clearly see the virtual scene element blocked by the previous illumination special effect.
(2) In response to that the virtual lighting prop equipped in the second virtual object is in an off state, the target condition is triggered.

For example, after the player controlling the second virtual object turns off the virtual lighting prop, the virtual lighting prop does not generate (or no longer generates) a lighting effect, and therefore cannot (or does not) perform line-of-sight blocking on the first virtual object. This may be considered as the target condition being triggered, to weaken displaying of the effect of the illumination special effect, and to display the virtual scene. In some arrangements, when the virtual lighting prop is turned off, the effect of the illumination special effect may be gradually weakened to cancel displaying, so that the player can completely clearly see the virtual scene at the current viewing angle of the first virtual object.
(3) In response to that the first virtual object does not match the lighting direction of the virtual lighting prop, the target condition is triggered.

For example, that the lighting direction does not match is configured for indicating that the first virtual object is not in an interference range determined based on the lighting direction. That is, although the second virtual object illuminates to the lighting direction by using the virtual lighting prop, if the first virtual object does not exist within the interference range determined based on the lighting direction, it is considered that the target condition is triggered. The effect of the illumination special effect is weakened, and the blocked virtual scene element may gradually appear. That is, the player can gradually clearly see the virtual scene element blocked by the previous illumination special effect.
(4) In response to the second virtual object being eliminated, the target condition is triggered.

For example, when the second virtual object is eliminated by the first virtual object or another virtual object and exits a virtual battle, the virtual lighting prop may become invalid, and the effect of the illumination special effect may be gradually weakened to cancel displaying, so that the player can completely clearly see the virtual scene at the current viewing angle of the first virtual object.
(5) In response to that a loss rate of the virtual lighting prop equipped in the second virtual object reaches a preset loss rate, the target condition is triggered.

For example, the loss rate may be configured for indicating a use loss degree of the virtual lighting prop. In some arrangements, when the virtual lighting prop is hit, a quantity of use times may increase, or the like, the loss rate of the virtual lighting prop may increase. When the loss rate of the virtual lighting prop reaches 100%, the virtual lighting prop may become invalid, and the effect of the illumination special effect may be gradually weakened to cancel displaying, so that the player can completely clearly see the virtual scene at the current viewing angle of the first virtual object.

In one or more examples, when the effect of the illumination special effect is weakened, displaying may be weakened in a constant-speed manner. For example, after the target condition is triggered, the effect of the illumination special effect may be evenly weakened, the illumination special effect may disappear after 3 seconds, and the virtual scene without line-of-sight blocking may be displayed again. For example, the illumination special effect may be implemented as a light cluster. When the effect of the illumination special effect is weakened, a disappearance animation in which the light cluster gradually disappears may be displayed, until the virtual scene without line-of-sight blocking is displayed again.

In some arrangements, the effect of the special effect may be related to the interference value of the illumination special effect. When displaying of the effect of the illumination special effect is weakened, the interference value may be changed at a constant speed, to weaken displaying of the effect of the illumination special effect in a constant-speed manner. For example, the interference value may be 60. When the target condition is triggered and displaying of the effect of the illumination special effect is weakened, the interference value may be reduced at a constant speed, and the effect of the special effect corresponding to the reduced interference value may be displayed. For example, after 1 second, the interference value may be reduced to 30 at a constant speed, so that the effect of the special effect corresponding to the interference value 30 may be displayed, and a process of slowly weakening is also performed within that 1 second.

In some examples, displaying of the effect of the illumination special effect may be weakened in a variable-speed manner. Alternatively, the illumination special effect may suddenly or immediately disappear in the virtual scene. The foregoing is only an example, and this is not limiting.

Additionally or alternatively, a skill cooling special effect may be displayed after the illumination special effect is displayed. The skill cooling special effect may be configured for reducing an attack frequency at which the first virtual object launches a virtual attack against the second virtual object. In some examples, after the illumination special effect is displayed, a failure picture of an attack function control may be displayed, and the failure picture may be considered as a skill cooling special effect. The attack function control may be configured for indicating a control associated with a virtual attack operation, and the failure picture may be configured for indicating that the first virtual object cannot launch a virtual attack against the second virtual object by using the attack function control within a skill cooling time, thereby further reducing an attack frequency at which the first virtual object launches a virtual attack against the second virtual object, increasing a prop effective duration of the virtual lighting prop, expanding a prop effective manner of the virtual lighting prop, and improving utilization of the virtual lighting prop.

In some arrangements, whether to display the illumination special effect may be determined according to virtual camps to which the first virtual object and the second virtual object belong. In some examples, the illumination special effect may be displayed in response to the first virtual object and the second virtual object belonging to different virtual camps. For example, when the first virtual object and the second virtual object have a hostile relationship, and the first virtual object is located within the interference range, a line-of-sight blocking effect generated by the second virtual object by using the virtual lighting prop may act on the first virtual object. That is, the illumination special effect may be displayed, to effectively protect the second virtual object by using the line-of-sight blocking effect.

According to some aspects, a brightness enhancement animation may be displayed in response to the first virtual object and the second virtual object belonging to the same virtual camp in a case that the second virtual object is within the viewing angle range of the first virtual object, and the virtual lighting prop equipped in the second virtual object is in the illumination state. The brightness enhancement animation may include an action of the second virtual object providing lighting for the first virtual object by using the virtual lighting prop.

For example, when the first virtual object and the second virtual object are in a teammate relationship, even if the first virtual object is located in the interference range corresponding to the lighting direction, the line-of-sight blocking effect generated by the second virtual object by using the virtual lighting prop might not act on the first virtual object. That is, the illumination special effect might not be displayed on a terminal interface corresponding to the first virtual object, thereby effectively avoiding the line-of-sight blocking effect for the first virtual object in the same camp, and affecting the virtual battle.

Therefore, differently displaying an illumination special effect according to a situation of a camp to which a virtual object belongs not only helps to avoid damage to a teammate in a process of using a virtual lighting prop, but also helps to cause targeted attack to an enemy in a group battle.

Accordingly, methods for canceling displaying of an illumination special effect are described. In response to triggering a target condition, an effect of the illumination special effect may be weakened, and a virtual scene may be displayed, so that the illumination special effect may be displayed in a weakened display manner, thereby enhancing a simulation feeling of a game.

In one or more arrangements, in addition to generating an illumination special effect, a virtual lighting device may be further configured to generate a lighting special effect, and the lighting special effect may be configured for enhancing display brightness of a virtual environment. A range in which displaying of the lighting special effect is triggered may be a virtual lighting range corresponding to the virtual lighting prop, and the virtual lighting range may be configured for indicating a range in which a lighting function of the virtual lighting prop is exerted. Using an example in which the virtual lighting prop is implemented as a virtual flashlight, a virtual scene may be displayed by combining a virtual lighting range and an interference range. For example, as shown in FIG. 11, aspects of FIG. 3 may further be implemented as the following operation 1110 to operation 1140.

Operation 1110: An illuminator uses a virtual flashlight.

The illuminator may be configured for indicating the second virtual object using the virtual lighting prop, and the virtual flashlight may be the virtual lighting prop. In some examples, based on use of the virtual flashlight by the illuminator, two determining paths may be simultaneously performed, that is, operation 1120 and operation 1130 may be performed at the same time, to display a virtual scene by combining a virtual lighting range and an interference range.

Operation 1120: Determine whether an illuminated person is within an interference range.

The illuminated person may be configured for indicating a first virtual object controlled by a player. In some examples, a lighting direction of the virtual flashlight may be determined based on an operation that the illuminator uses the virtual flashlight for illumination, and an interference range corresponding to the virtual flashlight may be determined based on the lighting direction. For example, as shown in FIG. 9, the interference range may be implemented as a sectoral region formed by using the illuminator as a vertex, a preset distance threshold as a radius, and a preset angle threshold as an angle. When it is determined whether the illuminated person is within the interference range, it may be determined whether the illuminated person is in a sectoral region of a screen in which a blinding special effect takes effect. The blinding special effect may be an illumination special effect configured for indicating line-of-sight blocking on the first virtual object.

In some arrangements, when the illuminated person is outside the interference range (no), the determining process may be ended. When the illuminated person is within the interference range (yes), operation 1121 may be performed.

Operation 1121: Determine a sub-interference range of the illuminated person within the interference range.

For example, the interference range may include a plurality of pre-divided interference sub-ranges. After it is determined that the illuminated person is within the interference range, the sub-interference range of the illuminated person within the interference range may be determined. As shown in FIG. 9, whether the illuminated person falls within the sub-interference range 931, the sub-interference range 932, or the sub-interference range 933 of the interference range may be determined.

Operation 1122: Calculate, in real time, an interference value of the illuminated person within the sub-interference range.

For example, after the sub-interference range of the illuminated person is determined, the interference value of the illuminated person within the sub-interference range may be determined. The interference value may be configured for indicating a degree of line-of-sight interference to the illuminated person.

In some examples, different sub-interference ranges may correspond to different interference effective rates, and the interference effective rate may be configured for indicating an interference rate at which line-of-sight interference is generated to the illuminated person. For example, it may be preset that when the sub-interference range is closer to the illuminator, the interference effective rate is higher. It may be preset that when the sub-interference range is farther from the illuminator, the interference effective rate is lower. For example, as shown in FIG. 9, the interference effective rate of the sub-interference range 931 is the maximum, and the interference effective rate of the sub-interference range 933 is the minimum.

In some arrangements, after the sub-interference range in which the illuminated person is located is determined, the interference effective rate corresponding to the sub-interference range in which the illuminated person is located may be determined, and the interference value of the illuminated person within the sub-interference range may be determined based on the interference effective rate and a staying duration of the illuminated person within the sub-interference range. For example, the interference effective rate corresponding to the sub-interference range may be multiplied by the staying duration of the illuminated person within the sub-interference range, to obtain the interference value of the illuminated person within the sub-interference range.

As shown in FIG. 9, when the illuminated person is within the sub-interference range 931, the interference effective rate corresponding to the sub-interference range 931 may be determined. If the illuminated person keeps moving within the sub-interference range 931, the staying duration of the illuminated person within the sub-interference range 931 may be collected, and the interference effective rate may be multiplied by the staying duration of the illuminated person within the sub-interference range 931 to obtain the interference value of the illuminated person within the sub-interference range 931.

In some arrangements, the plurality of sub-interference ranges may respectively correspond to interference value intervals. When the illuminated person moves among the plurality of sub-interference ranges, the interference value of the illuminated person in the sub-interference range may be updated based on the interference value interval corresponding to the sub-interference range. As shown in FIG. 9, at the beginning, the illuminated person may be located within the sub-interference range 931, a first staying duration of the illuminated person within the sub-interference range 931 may be collected, and a first interference value of the illuminated person within the sub-interference range 931 may be obtained. The first interference value may be located within a first interference value interval corresponding to the sub-interference range 931. For example, the first interference value interval corresponding to the sub-interference range 931 is (0, 100), and the first interference value is calculated to be 80. After the illuminated person moves from the sub-interference range 931 to the sub-interference range 932, a second interference value interval corresponding to the sub-interference range 932 may be determined. For example, the second interference value interval is (0, 60). If the first interference value is not within the second interference value interval, the first interference value may be reduced to the second interference value interval. For example, after the first interference value 80 is reduced to 60, the interference value 60 may be used as an updated interference value.

Operation 1123: Output a blinding special effect on a screen of the illuminated person according to the interference value.

For example, after the interference value is determined, the blinding special effect on the screen of the illuminated person may be determined based on a value status of the interference value. The blinding special effect may be a special effect configured for presenting line-of-sight blocking on the illuminated person. In some arrangements, different interference values may correspond to different degrees of blinding special effects. For example, when the interference value is 50, the blinding special effect may be the largest, and when the interference value is 30, the blinding special effect may be relatively small.

Operation 1130: Determine whether the illuminated person is located within a virtual lighting range.

For example, when whether the illuminated person is within the interference range is determined, whether the illuminated person is within the virtual lighting range may be determined. The virtual lighting range may be configured for indicating a range in which a lighting function of a virtual lighting device (a virtual flashlight) is exerted. In some arrangements, the virtual lighting range may be related to the lighting direction of the virtual flashlight, and the virtual lighting range may be determined based on the lighting direction of the virtual flashlight. For example, the virtual lighting range may be a sectoral region range of a particular area that is predetermined based on the lighting direction. Alternatively, the virtual lighting range may be a rectangular region of a particular area that is predetermined based on the lighting direction, or the like. In some examples, when the illuminated person is not located within the virtual lighting range, the process of determining whether the illuminated person is located within the virtual lighting range may be ended. When the illuminated person is located within the virtual lighting range, the following operation 1131 may be performed.

Operation 1131: Determine an angle between the illuminator and the illuminated person.

For example, when it is determined that the illuminated person is located in the virtual lighting range, a first orientation of the illuminated person and a second orientation of the illuminator may be determined, and an angle between the illuminated person and the illuminator may be determined based on the first orientation and the second orientation.

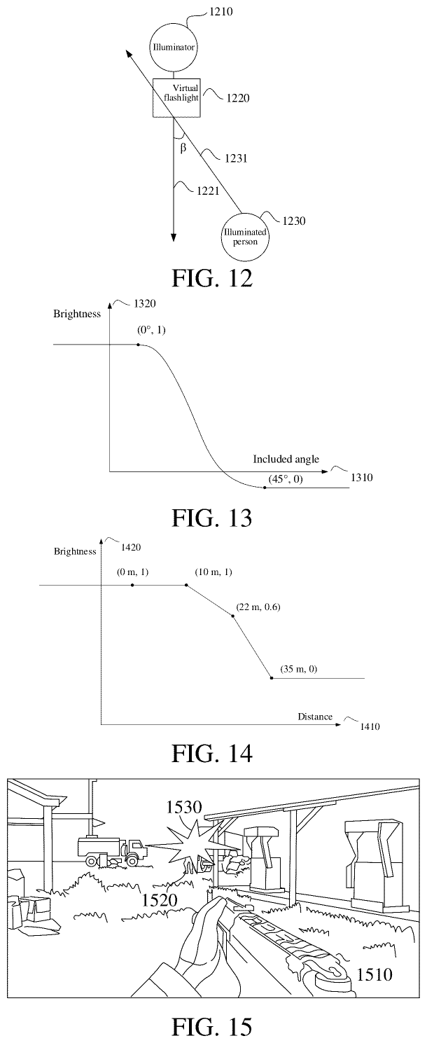

FIG. 12 is an example schematic diagram of a location relationship between an illuminator and an illuminated person. An illuminator 1210 may hold a virtual flashlight 1220, and illuminate by using the virtual flashlight 1220. The lighting direction may be the same as a first orientation 1221 of the illuminator. In addition, a second orientation 1231 of the illuminated person 1230 may be determined according to the location of the illuminated person 1230, and an angle between the first orientation 1221 and the second orientation 1231 may be determined, to obtain an angle between the illuminated person and the illuminator.

Operation 11311: Calculate a first brightness parameter of a halo special effect in this case.

The halo special effect may be configured for indicating a special effect displayed on a corresponding screen of the illuminated person, and the halo special effect may be a special effect generated by the virtual flashlight by performing the lighting function.

In some examples, a display effect of the halo special effect may be related to the angle between the illuminated person and the illuminator. For example, when the illuminated person is located within the virtual lighting range of the illuminator, the halo special effect may be generated at a model tip of the virtual flashlight of the illuminator. In some arrangements, the first brightness parameter of the halo special effect may be determined based on the angle between the illuminated person and the illuminator. The brightness parameter may be a brightness impact parameter that indicates to display the halo special effect. For example, the first brightness parameter related to an angle factor is determined based on the angle between the illuminated person and the illuminator. In some examples, the first luminance parameter related to the angle factor may be determined based on a luminance curve of a pre-configured angle-halo special effect.

As shown in FIG. 13, a horizontal axis 1310 may be the angle between the illuminator and the illuminated person, and a vertical axis 1320 may be the brightness of the halo special effect. It can be learned from FIG. 13 that, the brightness of the halo special effect may be brighter if the angle between the illuminator and the illuminated person is smaller. When the angle between the illuminator and the illuminated person is larger, the brightness of the halo special effect may be darker. After the angle between the illuminator and the illuminated person reaches a larger angle, the brightness of the halo special effect may become 0. For example, when the angle between the illuminator and the illuminated person is 0, the halo special effect may be 1, where “1” is configured for indicating that the halo special effect is the brightest. When the angle between the illuminator and the illuminated person is 45°, the halo special effect may be 0, where “0” is configured for indicating that the halo special effect is not displayed.

Operation 1132: Determine a linear distance between the illuminated person and the illuminator.

For example, when it is determined that the illuminated person is located in the virtual lighting range, a first location of the illuminated person and a second location of an illuminator may be determined, and the linear distance between the illuminated person and the illuminator may be determined based on the first location and the second location.

FIG. 12 is an example schematic diagram of a location relationship between an illuminator and an illuminated person. A first location of an illuminator 1210 and a second location of an illuminated person 1230 may be determined, and a linear distance between the illuminated person 1230 and the illuminator 1210 may be determined based on the first location and the second location.

Operation 11321: Calculate a second brightness parameter of the halo special effect in this case.

In some arrangements, in addition to being related to the angle between the illuminated person and the illuminator, the display effect of the halo special effect may also be related to the distance between the illuminated person and the illuminator. In some examples, the second brightness parameter of the halo special effect may be determined based on the linear distance between the illuminated person and the illuminator. The brightness parameter may be a brightness impact parameter that indicates to display the halo special effect. For example, the second brightness parameter related to a distance factor may be determined based on the linear distance between the illuminated person and the illuminator. In some examples, the second luminance parameter related to the distance factor may be determined based on a brightness curve of a pre-configured distance-halo special effect.

FIG. 14 is an example schematic diagram showing that a distance may affect a halo special effect. A horizontal axis 1410 may be configured for indicating a distance between an illuminator and an illuminated person, and a vertical axis 1420 may be brightness of a halo special effect. It can be learned from FIG. 14 that, the brightness of the halo special effect may be brighter if the distance between the illuminator and the illuminated person is smaller. As the distance between the illuminator and the illuminated person increases, different linear change relationships may be used to represent a change relationship between the distance and the halo special effect. This may be generally presented as “the brightness of the halo special effect is darker if the distance between the illuminator and the illuminated person is greater”, and the brightness of the halo special effect becomes 0 until or when the distance between the illuminator and the illuminated person reaches a relatively large distance.

For example, when the distance between the illuminator and the illuminated person is 0 m to 10 m, the halo special effect is 1, where “1” is configured for indicating that the halo special effect is the brightest. When the distance between the illuminator and the illuminated person is 10 m to 20 m, changes of the distance and the halo special effect may satisfy a first linear change relationship, and a change range of the halo special effect may be 1 to 0.6. When the distance between the illuminator and the illuminated person is 20 m to 35 m, changes of the distance and the halo special effect may satisfy a second linear change relationship, and a change range of the halo special effect may be 0.6 to 0. When the distance between the illuminator and the illuminated person is greater than 35 m, the halo special effect may be 0, where “0” is configured for indicating that the halo special effect is not displayed.

In some other arrangements, the second brightness parameter may be further configured for indicating a display size of the halo effect. A horizontal axis 1410 in FIG. 14 may be configured for indicating a distance between an illuminator and an illuminated person, and a vertical axis may be a special effect size of the halo special effect. It can be learned from FIG. 14 that, a smaller distance between the illuminator and the illuminated person may indicate a larger halo special effect. As the distance between the illuminator and the illuminated person increases, different linear change relationships may be used to represent a change relationship between the distance and the halo special effect. This may be generally presented as “a larger distance between the illuminator and the illuminated person indicates a smaller halo”, and the halo special effect disappears until or when the distance between the illuminator and the illuminated person reaches a larger distance.

For example, when the distance between the illuminator and the illuminated person is 0 m to 10 m, the size of the halo special effect may be 1, where “1” is configured for indicating that the halo special effect is the maximum. When the distance between the illuminator and the illuminated person is 10 m to 20 m, changes of the distance and the halo special effect may satisfy a first linear change relationship, and a change range of the size of the halo special effect may be 1 to 0.6. When the distance between the illuminator and the illuminated person is 20 m to 35 m, changes of the distance and the halo special effect may satisfy a second linear change relationship, and a change range of the size of the halo special effect may be 0.6 to 0. When the distance between the illuminator and the illuminated person is greater than 35 m, the halo special effect may be 0, where “0” is configured for indicating that the halo special effect is not displayed.

The foregoing is only an example, and is not limiting.

Operation 1133: The first brightness parameter and the second brightness parameter act together, to output a halo effect of the virtual flashlight.

For example, after the first brightness parameter related to the angle factor and the second brightness parameter related to the distance are obtained, the first brightness parameter and the second brightness parameter may be combined to obtain the halo effect of the virtual flashlight.

In some arrangements, a first weight value corresponding to the first brightness parameter and a second weight value corresponding to the second brightness parameter may be preset, and a total brightness parameter may be determined based on the first weight value, the second weight value, the first brightness parameter, and the second brightness parameter; and the halo effect of the virtual flashlight may be obtained based on the total brightness parameter.

For example, the first brightness parameter may be 1, and the first weight value of the first brightness parameter may be 0.5. The second brightness parameter may be 0.9, the second weight value of the second brightness parameter may be 0.5. After the first brightness parameter and the second brightness parameter may be obtained, the first weight value, the first brightness parameter, the second weight value, and the second brightness parameter may be combined to obtain the halo effect of the virtual flashlight. For example, it may be determined that the total brightness parameter is 0.75 (1*0.5+0.5*0.5), and the halo effect of the virtual flashlight may be displayed based on the total brightness parameter.

In some arrangements, the halo effect of the virtual flashlight may be obtained based on the halo brightness indicated by the first brightness parameter and the halo size indicated by the second brightness parameter. For example, if the first brightness parameter is 0.9 and the second brightness parameter is 0.2, the display brightness is 0.9 and the special effect size is 0.2. FIG. 15 is an example schematic interface diagram of a halo effect. An illuminated person holds a virtual attack prop 1510, an angle between the illuminated person and an illuminator 1520 is relatively small (which is almost equivalent to that the illuminated person and the illuminator 1520 face each other), and the first brightness parameter is relatively large (for example, 1), but there is a relatively long distance between the illuminated person and the illuminator 1520, and the second brightness parameter is relatively small (for example, 0.1). Therefore, the first brightness parameter and the second brightness parameter jointly act to output a halo effect 1530 of the virtual flashlight. The halo effect 1530 shown in FIG. 15 only shows a range of the halo special effect, and does not show a lighting effect of the halo special effect. For example, the halo special effect may implement a white light special effect.

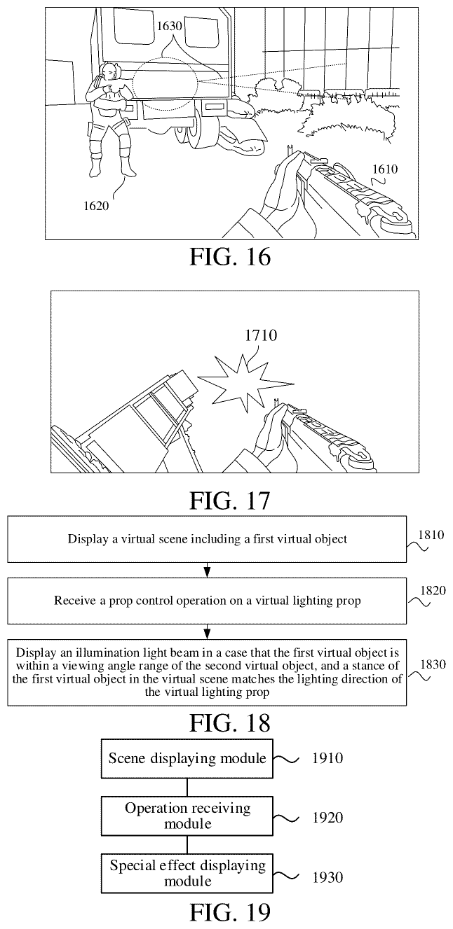

Similarly, FIG. 16 is another example schematic interface diagram of a halo effect. An illuminated person holds a virtual attack prop 1610, there is a relatively short distance between the illuminated person and an illuminator 1620, and the second brightness parameter is relatively large (for example, 0.8), but an angle between the illuminated person and the illuminator 1620 is relatively large, and the first brightness parameter is relatively small (for example, 0.2). Therefore, the first brightness parameter and the second brightness parameter jointly act to output a halo effect 1630 of the virtual flashlight. The halo effect 1630 shown in FIG. 16 only shows a range of the halo special effect, and does not show a lighting effect of the halo special effect.

An example representation form of a halo special effect is schematically presented in FIG. 16 and FIG. 17. This example is not limiting.

Operation 1140: Combine the halo effect and the blinding effect, to simulate an effect of being flashed by the virtual flashlight.

For example, in a process of performing illumination by the virtual flashlight, when an illuminated person is located in both a virtual lighting range and an interference range, a terminal screen corresponding to the illuminated person might not only display a halo effect corresponding to the virtual lighting range, but also display a blinding effect corresponding to the interference range.

In some examples, it may be preset that the interference range is less than the virtual lighting range; or it may be preset that the virtual lighting range is equal to the interference range; or it may be preset that the interference range is greater than the virtual lighting range; or it may be preset that the interference range partially overlaps with the virtual lighting range. Using an example in which it is preset that the interference range is less than the virtual lighting range, when the illuminated person is located within the interference range, the illuminated person may also be located within the virtual lighting range, and a halo effect and a blinding effect may be displayed in a combined manner on the terminal screen of the illuminated person. When the illuminated person is not located in the interference range but is located in the virtual lighting range, a halo effect may be displayed on the terminal screen of the illuminated person, and a blinding effect might not be displayed.

In one or more arrangements, as a location of the illuminated person or the illuminator changes, a relative location of the illuminated person or the illuminator changes, and the flashing effect of the virtual flashlight may also change. In some examples, the terminal may determine the relative location of the illuminated person or the illuminator in real time, and update the flashing effect of the virtual flashlight in real time.

In some examples, an illumination special effect disappearance animation may be displayed in response to the illuminated person moving out of the interference range. For example, as shown in FIG. 17, when the illuminated person (not shown in the figure) moves out of the interference range, an illumination special effect 1710 may slowly disappear until the virtual scene is displayed again. The illumination special effect 1710 shown in FIG. 17 merely shows a range of the illumination special effect, and does not show a lighting effect of the illumination special effect.

The foregoing content provides descriptions of displaying a virtual scene at a viewing angle of a first virtual object (an illuminated person). Content displayed in a virtual scene is described below at a viewing angle of a second virtual object (an illuminator). The first virtual object is a virtual object controlled by a player, and the second virtual object is another virtual object controlled by another player. For example, as shown in FIG. 18, the content displayed in the virtual scene at the viewing angle of the second virtual object may be implemented in the following operation 1810 to operation 1830. In some examples, the operations may be performed by a second device.

Operation 1810: Display a virtual scene including a first virtual object.

The virtual scene may be displayed at a viewing angle of a second virtual object, and the second virtual object may be equipped with a virtual lighting prop.

For example, the first virtual object and the second virtual object may be virtual objects controlled by different players. When the virtual scene is implemented as a scene displayed at the viewing angle of the second virtual object, the virtual scene may be a scene picture displayed on the second device (for example, a second terminal) controlling the second virtual object. The virtual lighting prop may be a virtual prop having a lighting function.

Operation 1820: Receive a prop control operation on a virtual lighting prop.

The prop control operation may be configured for adjusting a prop status of the virtual lighting prop to an illumination state.

For example, the prop status may be configured for describing a case in which the virtual lighting prop is operated by the second virtual object. The prop status may include at least one of a plurality of states such as an illumination state, a direction state, an appearance state, and a duration state.

The illumination state may be configured for describing an illumination situation of the virtual lighting prop. For example, if the second virtual object turns off the virtual lighting prop, the virtual lighting prop might not be in the illumination state. Alternatively, if the second virtual object turns on the virtual lighting prop, the virtual lighting prop may be in the illumination state. Alternatively, a default state after the virtual lighting prop is equipped may be the illumination state. Alternatively, a default state after the virtual lighting prop is equipped might not be the illumination state.

In some examples, the illumination state may further be configured for indicating a lighting level status of the virtual lighting prop. For example, the virtual lighting prop may have lighting classes of a plurality of levels, and when the second virtual object causes the virtual lighting prop to be at a lighting class of a first level, the illumination state of the virtual lighting prop may be relatively weak. When the second virtual object causes the virtual lighting prop to be at a lighting class of a second level, the illumination state of the virtual lighting prop may be relatively strong.

The direction state may be configured for describing a prop orientation situation of the virtual lighting prop. For example, if the second virtual object operates the virtual lighting prop to light the front, the direction status of the virtual lighting prop may be a front state. Alternatively, if the second virtual object operates the virtual lighting prop to light the obliquely front, the direction status of the virtual lighting prop may be an obliquely front state.

In some arrangements, the direction status may be the same as an object orientation of the second virtual object. For example, a prop orientation of the virtual lighting prop may change with the object orientation of the second virtual object, and when the object orientation of the second virtual object is the front, the prop orientation of the virtual lighting prop may be the front. Alternatively, there may be a difference between the direction status and the object orientation of the second virtual object. That is, the second virtual object may control the virtual lighting prop to light in a direction other than the object direction. For example, the object orientation of the second virtual object may be the front, but the prop orientation of the virtual lighting prop controlled by the second virtual object may be obliquely front.

The appearance status may be configured for describing a prop appearance situation of the virtual lighting prop. For example, the appearance status may include a color situation, a shape situation, and the like of the virtual lighting prop.

The duration status may be configured for describing duration of the illumination state of the virtual lighting prop. For example, if the virtual lighting prop needs the player controlling the second virtual object to continuously press the lighting control to play or activate the lighting function, the duration status may be determined based on a pressing duration for the lighting control. Alternatively, duration may be preset for the virtual lighting prop, and when the player controlling the second virtual object enables the virtual lighting prop, the terminal may automatically trigger a duration countdown, and use a countdown situation as the duration status of the virtual lighting prop.

In some arrangements, a movement control operation on the virtual lighting prop may be received.

The movement control operation may be configured for adjusting the lighting direction of the virtual lighting prop.

For example, when the object orientation is the same as the lighting direction, the player controlling the second virtual object may change the lighting direction of the virtual lighting prop by adjusting the object orientation of the second virtual object, and use an adjustment operation of adjusting the object orientation of the second virtual object as the movement control operation.

Alternatively, when the object orientation is different from the lighting direction, the player controlling the second virtual object may change the lighting direction of the virtual lighting prop by adjusting the prop orientation of the virtual lighting prop, and use an adjustment operation of adjusting the prop orientation of the virtual lighting prop as the movement control operation.

Additionally or alternatively, an on/off control operation on the virtual lighting prop may be received.

The on/off control operation may be configured for adjusting the illumination state of the virtual lighting prop.

For example, the virtual lighting prop may have two illumination states, namely, on and off. The illumination state may be implemented by using a prop enable control. When the virtual lighting prop is not in the illumination state (the prop enable control is in an off state), the virtual lighting prop may be enabled to enter the illumination state by triggering the prop enable control. When the virtual lighting prop is in the illumination state (the prop enable control is in an on state), the virtual lighting prop may be enabled not to be in the illumination state by triggering the prop enable control. That is, a manner of switching the illumination state may be implemented by using the prop enable control.

For example, the virtual lighting prop may further have a plurality of illumination states with different illumination intensities. The illumination states may be implemented by using an illumination adjustment control. The illumination adjustment control may include: turn-on, first-level, second-level, and turn-off. When the virtual lighting prop is not in the illumination state (the illumination adjustment control is in the turn-off state), the illumination adjustment control may be triggered, so that the virtual lighting prop enters the illumination state in the first level. When the illumination adjustment control is triggered again, the virtual lighting prop may enter the illumination state in the second level, and when the illumination adjustment control is triggered again, the virtual lighting prop might not be in the illumination state (e.g., turned off). That is, a manner of adjusting the illumination state may be implemented by using the illumination adjustment control.

The foregoing is only an example, and is not limiting.

Operation 1830: Display an illumination light beam in a case that the first virtual object is within a viewing angle range of the second virtual object, and a stance of the first virtual object in the virtual scene matches the lighting direction of the virtual lighting prop.

The illumination light beam may be configured for displaying, at an observation viewing angle of the first virtual object for the virtual scene, an illumination special effect for line-of-sight blocking. In some examples, the illumination light beam may be displayed at the viewing angle of the second virtual object corresponds to the illumination special effect displayed at the viewing angle of the first virtual object, and the illumination special effect may be configured for line-of-sight blocking at the observation viewing angle of the first virtual object for the virtual scene.

For example, in the virtual scene displayed at the viewing angle of the second virtual object, the illumination light beam may be displayed when the lighting direction of the virtual lighting prop operated by the second virtual object matches the stance of the first virtual object in the virtual scene, to differently present a special effect display difference between the illumination light beam corresponding to the first virtual object and the illumination special effect corresponding to the second virtual object.

In some arrangements, an illumination light beam of a first special effect situation may be displayed when the lighting direction of the virtual lighting prop matches the stance of the first virtual object in the virtual scene. An illumination light beam of a second special effect situation may be displayed when the lighting direction of the virtual lighting prop does not match the stance of the first virtual object in the virtual scene.

The special effect situation may be configured for indicating a display situation of the illumination light beam. In some examples, the special effect situation may include at least one of a plurality of situations such as a brightness intensity situation, a color situation, and a style situation.

Using an example in which the special effect situation is implemented as a brightness intensity situation, when the lighting direction of the virtual lighting prop matches the stance of the first virtual object in the virtual scene, an illumination light beam with a relatively high brightness intensity may be displayed, and when the lighting direction of the virtual lighting prop does not match the stance of the first virtual object in the virtual scene, an illumination light beam with a relatively low brightness intensity may be displayed.

Alternatively, using an example in which the special effect situation is implemented as a color situation, when the lighting direction of the virtual lighting prop matches the stance of the first virtual object in the virtual scene, a red illumination light beam may be displayed, and when the lighting direction of the virtual lighting prop does not match the stance of the first virtual object in the virtual scene, a yellow illumination light beam may be displayed.

Alternatively, using an example in which the special effect situation is implemented as a style situation, when the lighting direction of the virtual lighting prop matches the stance of the first virtual object in the virtual scene, an illumination light beam having a star special effect may be displayed, and when the lighting direction of the virtual lighting prop does not match the stance of the first virtual object in the virtual scene, an illumination light beam having no star special effect may be displayed.

The foregoing is only an example, and is not limiting.

Additionally or alternatively, the illumination light beam may be displayed in response to the first virtual object being located within an interference range corresponding to the lighting direction of the virtual lighting prop.

For example, the lighting direction of the virtual lighting prop may determine the interference range, and the interference range may be configured for indicating an effective range of line-of-sight blocking on the first virtual object. In some examples, whether the first virtual object is within the interference range may be determined in real time. Alternatively, whether the first virtual object is within the interference range may be periodically determined.

In some arrangements, the illumination light beam may be displayed when the first virtual object is within the interference range.

In these examples, displaying the content of the virtual scene at the viewing angle of the second virtual object is described. When a stance of a first virtual object in a virtual scene matches a lighting direction of a virtual lighting prop, a second virtual object can use the virtual lighting prop to cause line-of-sight blocking on the first virtual object, and an illumination light beam may be displayed on a screen of a terminal controlling the second virtual object, to remind a player controlling the second virtual object of a case in which the first virtual object is line-of-sight blocked by a virtual lighting device. This is beneficial to fully improving operation efficiency of the player controlling the second virtual object, and improving use experience and human computer interaction efficiency of the player.

FIG. 19 is a structural block diagram of an example virtual scene display apparatus. As shown in FIG. 19, the apparatus may include:

a scene displaying module 1910, configured to display a virtual scene at a viewing angle of a first virtual object, the virtual scene including a second virtual object, the second virtual object being equipped with a virtual lighting prop, and the virtual lighting prop being a virtual prop having a lighting function;

an operation receiving module 1920, configured to receive a control operation on the first virtual object, the control operation being configured for controlling the first virtual object to perform an activity in the virtual scene; and

a special effect displaying module 1930, configured to display an illumination special effect in response to a stance of the first virtual object in the virtual scene matching a lighting direction of the virtual lighting prop in a case that the second virtual object is within a viewing angle range of the first virtual object and the virtual lighting prop equipped in the second virtual object is in an illumination state, the illumination special effect being configured for line-of-sight blocking at an observation viewing angle of the first virtual object for the virtual scene.

In one or more arrangements, the special effect displaying module 1930 may be further configured to display the illumination special effect in response to the first virtual object being located within the interference range corresponding to the lighting direction of the virtual lighting prop.

In some examples, the special effect displaying module 1930 may be further configured to: display, in response to that a spacing distance between the first virtual object and the virtual lighting prop is less than a preset distance threshold, the illumination special effect based on the spacing distance.

The special effect displaying module 1930 may be further configured to: display the illumination special effect in response to an angle between an object orientation of the first virtual object and the lighting direction being less than a preset angle threshold.

The special effect displaying module 1930 may be further configured to display the illumination special effect based on display brightness corresponding to the spacing distance, the display brightness having a negative correlation with the spacing distance.

In some arrangements, the interference range may have a plurality of sub-interference ranges, and the plurality of sub-interference ranges correspond to different illumination special effect intensities; and

the special effect displaying module 1930 may be further configured to: display an illumination special effect having a first illumination special effect intensity in response to the first virtual object being located in a first sub-interference range of the interference range; and display an illumination special effect having a second illumination special effect intensity in response to the first virtual object being located in a second sub-interference range of the interference range; a first distance between the first sub-interference range and the virtual lighting prop being less than a second distance between the second sub-interference range and the virtual lighting prop, and the first illumination special effect intensity being greater than the second illumination special effect intensity.

The plurality of sub-interference ranges may respectively correspond to interference effective rates, and the interference effective rate may be configured for indicating an interference rate at which line-of-sight interference is generated to the first virtual object; and

the special effect displaying module 1930 may be further configured to: obtain an interference effective rate corresponding to the first sub-interference range in response to the first virtual object being located in the first sub-interference range of the interference range; obtain an interference value corresponding to the first virtual object based on staying duration of the first virtual object in the first sub-interference range and the interference effective rate; and display the illumination special effect having the first illumination special effect intensity based on the interference value.

The special effect displaying module 1930 may be further configured to: display the illumination special effect with a divergent effect by using the virtual lighting prop as a center of the illumination special effect, the divergent effect being an effect of diverging outward and weakening gradually by using the virtual lighting prop as a point having highest brightness.

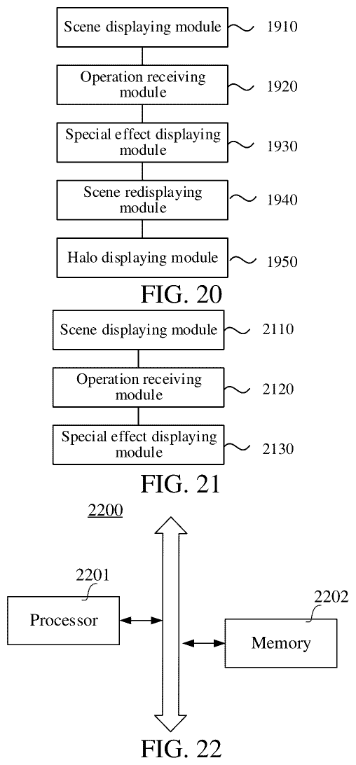

As shown in FIG. 20, optionally, the apparatus may further include:

a scene redisplaying module 1940, configured to weaken displaying of an effect of the illumination special effect in response to triggering a target condition; the target condition including at least one of the following: the second virtual object being outside the viewing angle range of the first virtual object, the virtual lighting prop equipped in the second virtual object being in an off state, and the first virtual object not matching the lighting direction of the virtual lighting prop.

In one or more arrangements, the virtual lighting prop may correspond to a virtual lighting range, and the virtual lighting range may be configured for indicating a range of the lighting function of the virtual lighting prop; and

the apparatus may further include:

a halo displaying module 1950, configured to display a virtual halo special effect in response to the first virtual object being located outside the interference range and being located within the virtual lighting range, the virtual halo special effect being a special effect formed by using the virtual lighting prop as a center.

According to one or more aspects, the special effect displaying module 1930 may be further configured to display a skill cooling special effect, the skill cooling special effect being configured for reducing an attack frequency at which the first virtual object launches a virtual attack against the second virtual object.

Additionally or alternatively, the special effect displaying module 1930 may be further configured to display the illumination special effect in response to the first virtual object and the second virtual object belonging to different virtual camps; or display a brightness enhancement animation in response to the first virtual object and the second virtual object belonging to the same virtual camp in a case that the second virtual object is within the viewing angle range of the first virtual object, and the virtual lighting prop equipped in the second virtual object being in the illumination state, the brightness enhancement animation including an action of the second virtual object providing illumination for the first virtual object by using the virtual lighting prop.

According to one or more aspects, the special effect displaying module 1930 may be further configured to display the illumination special effect in response to a first object level of the first virtual object being not greater than a second object level of the second virtual object; and skip displaying the illumination special effect in response to the first object level of the first virtual object being greater than the second object level of the second virtual object.

FIG. 21 is a structural block diagram of an example virtual scene display apparatus. As shown in FIG. 21, the apparatus may include:

a scene displaying module 2110, configured to display a virtual scene including a first virtual object, the virtual scene being displayed at a viewing angle of a second virtual object, the second virtual object being equipped with a virtual lighting prop, and the virtual lighting prop being a virtual prop having a lighting function;

an operation receiving module 2120, configured to receive a prop control operation on the virtual lighting prop, the prop control operation being configured for adjusting a prop status of the virtual lighting prop; and

a special effect displaying module 2130, configured to display an illumination special effect in a case that the first virtual object is within a viewing angle range of the second virtual object, the prop status of the virtual lighting prop is presented as an illumination state, and a stance of the first virtual object in the virtual scene matches a lighting direction of the virtual lighting prop, the illumination special effect being configured for line-of-sight blocking at an observation viewing angle of the first virtual object for the virtual scene.

According to one or more aspects, the special effect displaying module 2130 may be configured to display the illumination special effect in response to the first virtual object being located within the interference range corresponding to the lighting direction of the virtual lighting prop.

The operation receiving module 2120 may further be configured to receive a movement control operation on the virtual lighting prop, the movement control operation being configured for adjusting the lighting direction of the virtual lighting prop; or receive an on/off control operation on the virtual lighting prop, the on/off control operation being configured for adjusting the illumination state of the virtual lighting prop.

According to the virtual scene display apparatus described herein, in addition to the lighting utility of the virtual lighting prop, line-of-sight blocking utility is added to the virtual lighting prop based on the matching relationship between the lighting direction of the first virtual object and the virtual lighting prop, so that line-of-sight blocking is performed, by using the virtual lighting prop, on the first virtual object that conforms to the matching relationship, to interfere with an attack form of the first virtual object, thereby reducing an effective attack probability of the first virtual object, increasing an interest of a game, and further avoiding a problem that when a player uses the lighting virtual prop, the player can interfere with the first virtual object only by using an additional operation, thereby fully improving efficiency of human computer interaction.

The virtual scene display apparatus described herein is illustrated with an example of division of the foregoing functional modules. In actual application, the functions may be allocated to and completed by different functional modules according to requirements, that is, the internal structure of the device is divided into different functional modules, to implement all or some of the functions described above. For the specific implementation process, refer to the methods described. Details are not described herein again.

FIG. 22 is a structural block diagram of an example electronic device 2200. The electronic device 2200 may be a portable mobile terminal, such as a smartphone, an in-vehicle terminal, a tablet computer, a Moving Picture Experts Group Audio Layer III (MP3) player, a Moving Picture Experts Group Audio Layer IV (MP4) player, a laptop computer, or a desktop computer. The electronic device 2200 may also be referred to as user equipment, a portable terminal, a laptop terminal, or a desktop terminal.

In some arrangements, the electronic device 2200 includes: a processor 2201 and a memory 2202.

The processor 2201 may include one or more processing cores, for example, a 4-core processor or an 8-core processor. The processor 2201 may be implemented in at least one hardware form of a digital signal processor (DSP), a field-programmable gate array (FPGA), and a programmable logic array (PLA). The processor 2201 may alternatively include a main processor and a coprocessor. The main processor may be configured to process data in an active state, also referred to as a central processing unit (CPU). The coprocessor may be a low-power processor configured to process data in a standby state. In some examples, the processor 2201 may be integrated with a graphics processing unit (GPU). The GPU may be configured to render and draw content that needs to be displayed on a display screen. In some arrangements, the processor 2201 may further include an artificial intelligence (AI) processor. The AI processor may be configured to process computing operations related to machine learning.

The memory 2202 may include one or more computer-readable storage media. The computer-readable storage medium may be non-transient. The memory 2202 may further include a high-speed random access memory and a nonvolatile memory, for example, one or more disk storage devices or flash storage devices. In some examples, the non-transient computer-readable storage medium in the memory 2202 may be configured to store at least one instruction. The at least one instruction may be executed by the processor 2201 to perform the virtual scene display methods described herein.

In some arrangements, the electronic device 2200 further includes one or more sensors. The one or more sensors may include but are not limited to a proximity sensor, a gyroscope sensor, and a pressure sensor.

The proximity sensor, which may also be referred to as a distance sensor, may be generally disposed on a front panel of the electronic device 2200. The proximity sensor may be configured to collect a distance between the user and the front surface of the electronic device 2200.

The gyroscope sensor may detect a body direction and a rotation angle of the electronic device 2200, and the gyroscope sensor may work with the acceleration sensor to collect a 3D action performed by the user on the electronic device 2200. The processor 2201 may implement the following functions according to the data acquired by the gyroscope sensor: motion sensing (such as changing the UI according to a tilt operation of the user), image stabilization at shooting, game control, and inertial navigation.

The pressure sensor may be disposed at a side frame of the electronic device 2200 and/or a lower layer of the display screen. When the pressure sensor is disposed at the side frame of the electronic device 2200, a holding signal of the user on the electronic device 2200 may be detected. The processor 2201 may perform left/right hand recognition or a quick operation according to the holding signal acquired by the pressure sensor. When the pressure sensor is disposed on the low layer of the display screen, the processor 2201 may control, according to a pressure operation of the user on the display screen, an operable control on the UI. The operable control may include at least one of a button control, a scroll-bar control, an icon control, and a menu control.

In some examples, the electronic device 2200 may further include other components. A person skilled in the art may understand that the structure shown in FIG. 22 is not limiting on devices, components and other structures that may be part of the electronic device 2200, and that the electronic device 2200 may include more or fewer components than those shown in the figure, a combination of some components, or different component arrangements.

Aspects described herein further provide a computer device, which can be implemented as a terminal or a server as shown in FIG. 2. The computer device may include a processor and a memory. The memory may have at least one instruction, at least one segment of program, a code set, or an instruction set stored therein, and the at least one instruction, the at least one segment of program, the code set, or the instruction set may be loaded and executed by the processor to implement the virtual scene display methods. Aspects further provide a computer-readable storage medium storing at least one instruction, at least one segment of program, a code set, or an instruction set, and the at least one instruction, at least one segment of program, code set, or instruction set being loaded and executed by a processor to implement the virtual scene display methods. Aspects further provide a computer program product or a computer program. The computer program product or the computer program may include computer instructions, and the computer instructions may be stored in a computer-readable storage medium. A processor of a computer device may read the computer instructions from the computer-readable storage medium and execute the computer instructions, to enable the computer device to perform the foregoing virtual scene display methods described herein.

In some examples, the computer-readable storage medium may include: a read-only memory (ROM), a random access memory (RAM), a solid state drive (SSD), an optical disc, or the like. The RAM may include a resistance random access memory (ReRAM) and a dynamic random access memory (DRAM). The sequence numbers of the foregoing descriptions are merely illustrative and do not indicate a particular preference.

A person of ordinary skill in the art may understand that all or some of the steps described herein may be implemented by hardware, or may be implemented by a program instructing relevant hardware. The program may be stored in a computer-readable storage medium. The storage medium may be a read-only memory, a magnetic disk, an optical disc, or the like.

The foregoing descriptions are merely illustrative, and are not intended to be limiting. Any modification, equivalent replacement, or improvement made within the spirit and principle of this application shall fall within the protection scope of this application.

What is claimed is:

1. A virtual scene display method, performed by a first computing device, and the method comprising:
generating, by the first computing device, a display of a virtual scene at a viewing angle of a first virtual object, the virtual scene comprising a second virtual object, the second virtual object being equipped with a virtual lighting prop, and the virtual lighting prop being a virtual prop having a lighting function;
receiving, by the first computing device, a control operation on the first virtual object, the control operation being configured for controlling the first virtual object to perform an action in the virtual scene; and
generating, by the first computing device, a display of an illumination special effect in response to determining that a stance of the first virtual object in the virtual scene matches a lighting direction of the virtual lighting prop in a case that the second virtual object is within a viewing angle range of the first virtual object and the virtual lighting prop equipped in the second virtual object is in an illumination state, the illumination special effect being configured for line-of-sight blocking at an observation viewing angle of the first virtual object for the virtual scene.

2. The method according to claim 1, wherein determining that a stance of the first virtual object in the virtual scene matches a lighting direction of the virtual lighting prop comprises:
determining that the stance of the first virtual object in the virtual scene is within an interference range corresponding to the lighting direction of the virtual lighting prop.

3. The method according to claim 2, wherein the generating the display of the illumination special effect in response to determining that the stance of the first virtual object in the virtual scene is within an interference range corresponding to the lighting direction of the virtual lighting prop comprises:
generating, in response to determining that a spacing distance between the first virtual object and the virtual lighting prop is less than a preset distance threshold, the display of the illumination special effect based on the spacing distance.

4. The method according to claim 3, wherein the generating the display of the illumination special effect based on the spacing distance comprises:
generating the display of the illumination special effect based on an illumination special effect intensity corresponding to the spacing distance, the illumination special effect intensity being configured for indicating display brightness corresponding to the illumination special effect, and the illumination special effect intensity having a negative correlation with the spacing distance.

5. The method according to claim 4, wherein the interference range has a plurality of sub-interference ranges, and the plurality of sub-interference ranges correspond to different illumination special effect intensities; and
generating the display of the illumination special effect based on display brightness corresponding to the spacing distance comprises:
generating the display of the illumination special effect with a first illumination special effect intensity in response to determining that the first virtual object is located in a first sub-interference range of the interference range; and
generating the display of the illumination special effect with a second illumination special effect intensity in response to determining that the first virtual object is located in a second sub-interference range of the interference range;
wherein a first distance between the first sub-interference range and the virtual lighting prop is less than a second distance between the second sub-interference range and the virtual lighting prop, and the first illumination special effect intensity is greater than the second illumination special effect intensity.

6. The method according to claim 5, wherein the plurality of sub-interference ranges respectively correspond to interference effective rates, and each of the interference effective rates is configured for indicating a respective interference rate at which line-of-sight interference is generated to the first virtual object; and
generating the displaying an illumination special effect with the first illumination special effect intensity in response to determining that the first virtual object is located in the first sub-interference range of the interference range comprises:
determining an interference effective rate corresponding to the first sub-interference range in response to determining that the first virtual object is located in the first sub-interference range of the interference range;
determining an interference value corresponding to the first virtual object based on a staying duration of the first virtual object in the first sub-interference range and the determined interference effective rate corresponding to the first sub-interference range; and
generating the display of the illumination special effect with the first illumination special effect intensity based on the determined interference value.

7. The method according to claim 2, wherein generating the display of the illumination special effect in response to determining that the stance of the first virtual object in the virtual scene is within an interference range corresponding to the lighting direction of the virtual lighting prop comprises:
generating the display of the illumination special effect in response to determining that an angle between an object orientation of the first virtual object and the lighting direction is less than a preset angle threshold.

8. The method according to claim 1, wherein the generating the display of the illumination special effect comprises:
generating the display of the illumination special effect with a divergent effect by using the virtual lighting prop as a center of the illumination special effect, the divergent effect being an effect of diverging outward and weakening gradually by using the virtual lighting prop as a point having highest brightness.

9. The method according to claim 1, the method further comprising, after generating the display of the illumination special effect:
weakening the display of the illumination special effect in response to determining that a target condition has been triggered;
the target condition comprising at least one of the following: the second virtual object being outside the viewing angle range of the first virtual object, the virtual lighting prop equipped in the second virtual object being in an off state, and the first virtual object not matching the lighting direction of the virtual lighting prop.

10. The method according to claim 2, wherein the virtual lighting prop corresponds to a virtual lighting range, and the virtual lighting range is configured for indicating a lighting range of the lighting function of the virtual lighting prop; and
wherein the method further comprises:
generating a display of a virtual halo special effect in response to determining that the first virtual object is located outside the interference range and is located within the virtual lighting range, the virtual halo special effect being a special effect formed by using the virtual lighting prop as a center of illumination.

11. The method according to claim 1, after the displaying the illumination special effect, further comprising:
generating a display of a skill cooling special effect, the skill cooling special effect being configured for reducing an attack frequency at which the first virtual object is able to launch a virtual attack against the second virtual object.

12. The method according to claim 1, wherein the method further comprises:
generating a display of the illumination special effect in response to that the first virtual object and the second virtual object belong to different virtual camps;
or
generating a display of a brightness enhancement animation in response to determining that the first virtual object and the second virtual object belong to a same virtual camp in a case that the second virtual object is within the viewing angle range of the first virtual object, and the virtual lighting prop equipped in the second virtual object is in the illumination state, the brightness enhancement animation comprising an action of the second virtual object providing illumination for the first virtual object by using the virtual lighting prop.

13. The method according to claim 1, wherein the method further comprises:
generating the display of the illumination special effect in response to determining that a first object level of the first virtual object is not greater than a second object level of the second virtual object; and
not generating the display of the illumination special effect in response to determining that the first object level of the first virtual object is greater than the second object level of the second virtual object.

14. An apparatus comprising:
a processor; and
memory storing computer-readable instructions that, when executed, cause the apparatus to:
generate a display of a virtual scene at a viewing angle of a first virtual object, the virtual scene comprising a second virtual object, the second virtual object being equipped with a virtual lighting prop, and the virtual lighting prop being a virtual prop having a lighting function;
receive a control operation on the first virtual object, the control operation being configured for controlling the first virtual object to perform an action in the virtual scene; and
generate a display of an illumination special effect in response to determining that a stance of the first virtual object in the virtual scene matches a lighting direction of the virtual lighting prop in a case that the second virtual object is within a viewing angle range of the first virtual object and the virtual lighting prop equipped in the second virtual object is in an illumination state, the illumination special effect being configured for line-of-sight blocking at an observation viewing angle of the first virtual object for the virtual scene.

15. The apparatus according to claim 14, wherein the determining that a stance of the first virtual object in the virtual scene matches a lighting direction of the virtual lighting prop comprises:
determining that the stance of the first virtual object in the virtual scene is within an interference range corresponding to the lighting direction of the virtual lighting prop.

16. The apparatus according to claim 15, wherein the generating the display of the illumination special effect in response to determining that the stance of the first virtual object in the virtual scene is within an interference range corresponding to the lighting direction of the virtual lighting prop comprises:
generating, in response to determining that a spacing distance between the first virtual object and the virtual lighting prop is less than a preset distance threshold, the display of the illumination special effect based on the spacing distance.

17. The apparatus according to claim 16, wherein the generating the display of the illumination special effect based on the spacing distance comprises:
generating the display of the illumination special effect based on an illumination special effect intensity corresponding to the spacing distance, the illumination special effect intensity being configured for indicating display brightness corresponding to the illumination special effect, and the illumination special effect intensity having a negative correlation with the spacing distance.

18. A non-transitory computer-readable medium storing computer-readable instructions that, when executed, cause an apparatus to:
generate a display of a virtual scene at a viewing angle of a first virtual object, the virtual scene comprising a second virtual object, the second virtual object being equipped with a virtual lighting prop, and the virtual lighting prop being a virtual prop having a lighting function;
receive a control operation on the first virtual object, the control operation being configured for controlling the first virtual object to perform an action in the virtual scene; and
generate a display of an illumination special effect in response to determining that a stance of the first virtual object in the virtual scene matches a lighting direction of the virtual lighting prop in a case that the second virtual object is within a viewing angle range of the first virtual object and the virtual lighting prop equipped in the second virtual object is in an illumination state, the illumination special effect being configured for line-of-sight blocking at an observation viewing angle of the first virtual object for the virtual scene.

19. The non-transitory computer-readable medium according to claim 17, wherein the determining that a stance of the first virtual object in the virtual scene matches a lighting direction of the virtual lighting prop comprises:
determining that the stance of the first virtual object in the virtual scene is within an interference range corresponding to the lighting direction of the virtual lighting prop.

20. The non-transitory computer-readable medium according to claim 18, wherein the generating the display of the illumination special effect in response to determining that the stance of the first virtual object in the virtual scene is within an interference range corresponding to the lighting direction of the virtual lighting prop comprises:
generating, in response to determining that a spacing distance between the first virtual object and the virtual lighting prop is less than a preset distance threshold, the display of the illumination special effect based on the spacing distance.
